(19) United States
(12) Patent Application Publication
(10) Pub. No.: US 2016/0270386 A1
(43) Pub. Date: Sep. 22, 2016

(54) STRING APPARATUSES INCLUDING DIATOMACEOUS EARTH

(71) Applicant: Roderick William PHILLIPS, Vancouver (CA)

(72) Inventor: Roderick William PHILLIPS, Vancouver (CA)

(21) Appl. No.: 15/074,926

(22) Filed: Mar. 18, 2016

Related U.S. Application Data
(60) Provisional application No. 62/135,890, filed on Mar. 20, 2015.

(51) Int. Cl. A01M 1/00

(52) U.S. Cl. CPC A01M 1/00

(57) ABSTRACT

There is disclosed a string apparatus including a cord combined with diatomaceous earth. There are also disclosed uses of the string apparatus, and methods of using the string apparatus, for pest control. There are also disclosed methods of producing the string apparatus.

### RELATED APPLICATIONS

This application claims the benefit of, and priority to, U.S. provisional patent application No. 62/135,890 filed on Mar. 20, 2015.

The entire contents of U.S. provisional patent application No. 61/482,067 filed on May 3, 2011, U.S. provisional patent application No. 61/563,220 filed on Nov. 23, 2011, of U.S. patent application Ser. No. 14/114,900 (a United States national stage of PCT international patent application no. PCT/CA2012/000389 filed at the Canadian receiving office of the PCT on Apr. 26, 2012), of U.S. patent application Ser. No. 14/222,335 (a continuation of PCT international patent application no. PCT/CA2012/001015 filed at the Canadian receiving office of the PCT on Nov. 1, 2012), of Canadian patent application no. 2847388 filed on Mar. 21, 2014, of U.S. provisional patent application No. 62/135,890 filed on Mar. 20, 2015, and of PCT international patent application no. PCT/CA2015/000183 filed at the Canadian receiving office of the PCT on Mar. 20, 2015 are incorporated by reference herein.

### FIELD

The invention relates generally to pest control, and more particularly to string apparatuses, uses of the string apparatuses, and methods of using and producing the string apparatuses.

### RELATED ART

Many insects have become pests in many parts of the world. Some known methods of controlling bedbug populations involve using synthetic pesticides, but some pesticides may be harmful to humans and to other life. Other known methods of controlling bedbug populations include applying diatomaceous earth, a naturally occurring siliceous sedimentary rock that includes fossilized remains of diatoms.

However, known methods of applying diatomaceous earth can be cumbersome. For example, known methods of applying diatomaceous earth may undesirably require handling the diatomaceous earth, for example to transfer the diatomaceous earth from a container not having an applicator to a separate applicator apparatus. Also, known applicator apparatuses may apply diatomaceous earth unevenly, which may be wasteful or ineffective. In general, known methods of applying diatomaceous earth may be sufficiently complex so as to require professional involvement, which may undesirably add to cost and delay of bedbug treatment.

Also, numerous types of diatomaceous earth are available, and different types of diatomaceous earth vary widely and significantly from each other. It has been estimated that there are approximately 100,000 extant diatom species, and some diatomaceous earth may also include diverse combinations of one or more diatom species and may also include extinct species in addition to the number of extant species. Diatom skeletons (which may also be referred to as “frustules”) may vary widely and significantly in size and shape across a very large number of diatom species. Also, different insect species have different bodies that may be affected significantly differently by different types of diatomaceous earth. Therefore, many varieties of diatomaceous earth are available, and a variety of diatomaceous earth that is effective at controlling a population of one type of insect may not be as effective, or effective at all, at controlling a population of another type of insect.

### SUMMARY

According to one illustrative embodiment, there is provided a string apparatus comprising a cord combined with diatomaceous earth.

In some embodiments, the cord comprises twine.

In some embodiments, the cord comprises a generally cylindrical core of fibers.

In some embodiments, at least some of the fibers have end portions that are loose and extend freely away from the core.

In some embodiments, at least some of the diatomaceous earth is on at least some of the end portions.

In some embodiments, at least some of the diatomaceous earth is on an exterior surface of the core.

In some embodiments, the diatomaceous earth comprises remains of pennate diatoms.

In some embodiments, the pennate diatoms comprise Fragilariophyceae diatoms.

In some embodiments, the Fragilariophyceae diatoms comprise Fragilariales diatoms.

In some embodiments, the Fragilariales diatoms comprise Fragilariaceae diatoms.

In some embodiments, the Fragilariaceae diatoms comprise Synedra diatoms.

In some embodiments, the Fragilariaceae diatoms comprise Tabularia diatoms.

In some embodiments, the Fragilariaceae diatoms comprise Fragilaria diatoms.

In some embodiments, the diatomaceous earth comprises remains of diatoms having frustules having widths less than about 5 micrometers and lengths greater than about 20 micrometers.

In some embodiments, the diatomaceous earth comprises remains of diatoms having frustules having widths less than about 3 micrometers and lengths greater than about 20 micrometers.

In some embodiments, the diatomaceous earth comprises remains of diatoms having frustules having widths less than about 5 micrometers and lengths greater than about 30 micrometers.

In some embodiments, the diatomaceous earth comprises remains of diatoms having frustules having widths less than about 3 micrometers and lengths greater than about 30 micrometers.

In some embodiments, the diatomaceous earth comprises CELATOM™ MN-51.

In some embodiments, the diatomaceous earth is heat-treated.

In some embodiments, the diatomaceous earth is flash dried.

In some embodiments, the diatomaceous earth is flash dried at about 480° C.

In some embodiments, the diatomaceous earth comprises diatomaceous earth from Clark Station, Nev., United States of America.

In some embodiments, the diatomaceous earth is a smaller size fraction of size-separated diatomaceous earth.

In some embodiments, the smaller size fraction is a smaller size fraction of particles less than about 11 micrometers in size.

In some embodiments, a PA1b-related peptide is intermixed with the diatomaceous earth.

In some embodiments, saponin is intermixed with the diatomaceous earth.

According to another illustrative embodiment, there is provided use of the apparatus to control a population of insects.

According to another illustrative embodiment, there is provided use of the apparatus to control a population of bedbugs.

According to another illustrative embodiment, there is provided use of the apparatus to control a population of Cimicidae.

According to another illustrative embodiment, there is provided use of the apparatus to control a population of Cimex.

According to another illustrative embodiment, there is provided use of the apparatus to control a population of Cimex lectularius.

According to another illustrative embodiment, there is provided use of the apparatus to control a population of silverfish.

According to another illustrative embodiment, there is provided use of the apparatus to control a population of Lepisma saccharina.

According to another illustrative embodiment, there is provided use of the apparatus to control a population of Lepismatidae.

According to another illustrative embodiment, there is provided use of the apparatus to control a population of Thysanura.

According to another illustrative embodiment, there is provided use of the apparatus to control a population of cockroaches.

According to another illustrative embodiment, there is provided use of the apparatus to control a population of Blattella germanica.

According to another illustrative embodiment, there is provided use of the apparatus to control a population of Blattellinae.

According to another illustrative embodiment, there is provided use of the apparatus to control a population of Dictyoptera.

According to another illustrative embodiment, there is provided use of the apparatus to control a population of crickets.

According to another illustrative embodiment, there is provided use of the apparatus to control a population of Acheta domesticus.

According to another illustrative embodiment, there is provided use of the apparatus to control a population of Gryllidae.

According to another illustrative embodiment, there is provided use of the apparatus to control a population of Orthoptera.

According to another illustrative embodiment, there is provided use of the apparatus to control a population of arachnids.

According to another illustrative embodiment, there is provided a method of controlling a population of pests, the method comprising positioning the apparatus in a location where the pests travel.

In some embodiments, positioning the apparatus comprises tying at least one plant with the apparatus.

In some embodiments, the pests comprise insects.

In some embodiments, the insects comprise bedbugs.

In some embodiments, the bedbugs comprise Cimicidae.

In some embodiments, the bedbugs comprise Cimex.

In some embodiments, the bedbugs comprise Cimex lectularius.

In some embodiments, the insects comprise silverfish.

In some embodiments, the insects comprise Lepisma saccharina.

In some embodiments, the insects comprise Lepismatidae.

In some embodiments, the insects comprise Thysanura.

In some embodiments, the insects comprise cockroaches.

In some embodiments, the insects comprise Blattella germanica.

In some embodiments, the insects comprise Blattellinae.

In some embodiments, the insects comprise Dictyoptera.

In some embodiments, the insects comprise crickets.

In some embodiments, the insects comprise Acheta domesticus.

In some embodiments, the insects comprise Gryllidae.

In some embodiments, the insects comprise Orthoptera.

In some embodiments, the pests comprise arachnids.

According to another illustrative embodiment, there is provided a method of manufacturing a string apparatus, the method comprising combining a cord with diatomaceous earth.

In some embodiments, a PA1b-related peptide is intermixed with the diatomaceous earth.

In some embodiments, saponin is intermixed with the diatomaceous earth.

In some embodiments, combining the cord with the diatomaceous earth comprises pulling the cord through the diatomaceous earth.

According to another illustrative embodiment, there is provided a method of manufacturing a string apparatus, the method comprising: size separating diatomaceous earth into a smaller size fraction and into a larger size fraction; and combining a cord with the smaller size fraction.

In some embodiments, the smaller size fraction is a smaller size fraction of particles less than about 11 micrometers in size.

In some embodiments, a PA1b-related peptide is intermixed with the smaller size fraction.

In some embodiments, saponin is intermixed with the smaller size fraction.

In some embodiments, combining the cord with the smaller size fraction comprises pulling the cord through the smaller size fraction.

In some embodiments, the diatomaceous earth comprises remains of pennate diatoms.

In some embodiments, the pennate diatoms comprise Fragilariophyceae diatoms.

In some embodiments, the Fragilariophyceae diatoms comprise Fragilariales diatoms.

In some embodiments, the Fragilariales diatoms comprise Fragilariaceae diatoms.

In some embodiments, the Fragilariaceae diatoms comprise Synedra diatoms.

In some embodiments, the Fragilariaceae diatoms comprise Tabularia diatoms.

In some embodiments, the Fragilariaceae diatoms comprise Fragilaria diatoms.

In some embodiments, the diatomaceous earth comprises remains of diatoms having frustules having widths less than about 3 micrometers and lengths greater than about 20 micrometers.

In some embodiments, the diatomaceous earth comprises remains of diatoms having frustules having widths less than about 5 micrometers and lengths greater than about 20 micrometers.

In some embodiments, the diatomaceous earth comprises remains of diatoms having frustules having widths less than about 3 micrometers and lengths greater than about 30 micrometers.

In some embodiments, the diatomaceous earth comprises remains of diatoms having frustules having widths less than about 5 micrometers and lengths greater than about 30 micrometers.

In some embodiments, the diatomaceous earth comprises CELATOM™ MN-51.

In some embodiments, the diatomaceous earth is heat-treated.

In some embodiments, the diatomaceous earth is flash dried.

In some embodiments, the diatomaceous earth is flash dried at about 480° C.

In some embodiments, the diatomaceous earth comprises diatomaceous earth from Clark Station, Nev., United States of America.

In some embodiments, the cord comprises twine.

In some embodiments, the cord comprises a generally cylindrical core of fibers.

In some embodiments, at least some of the fibers have end portions that are loose and extend freely away from the core.

Other aspects and features of the present invention will become apparent to those ordinarily skilled in the art upon review of the following description of illustrative embodiments in conjunction with the accompanying figures.

### BRIEF DESCRIPTION OF THE DRAWINGS

In the drawings:

FIG. 1 is a perspective view of a string apparatus according to one illustrative embodiment, and of an apparatus for producing the string apparatus according to one illustrative embodiment;

FIGS. 2 to 5 are secondary electron images of diatomaceous earth known as CELATOM™ MN-51;

FIG. 6 is a Rietveld refinement plot of the diatomaceous earth known as CELATOM™ MN-51;

FIG. 7 is a graph of particle size distribution of the diatomaceous earth known as CELATOM™ MN-51;

FIG. 8 is a secondary electron image of diatomaceous earth known as CELATOM™ MN-53;

FIG. 9 is a Rietveld refinement plot of the diatomaceous earth known as CELATOM™ MN-53;

FIG. 10 is a secondary electron image of diatomaceous earth known as Alpine™ Dust;

FIG. 11 is a Rietveld refinement plot of the diatomaceous earth known as Alpine™ Dust;

FIG. 12 is a secondary electron image of diatomaceous earth known as MotherEarth™ D;

FIG. 13 is a Rietveld refinement plot of the diatomaceous earth known as MotherEarth™ D;

FIG. 14 is a graph of particle size distribution of the diatomaceous earth known as MotherEarth™ D;

FIGS. 15 to 17 are secondary electron images of diatomaceous earth known as PRO-ACTIVE™;

FIG. 18 is a Rietveld refinement plot of the diatomaceous earth known as PRO-ACTIVE™;

FIG. 19 is a scanning electron microscope image of a smaller size fraction of the diatomaceous earth known as CELATOM™ MN-51; and

FIG. 20 is a scanning electron microscope image of a larger size fraction of the diatomaceous earth known as CELATOM™ MN-51.

### DETAILED DESCRIPTION

### A. String Apparatus and Method and Apparatus for Producing the String Apparatus

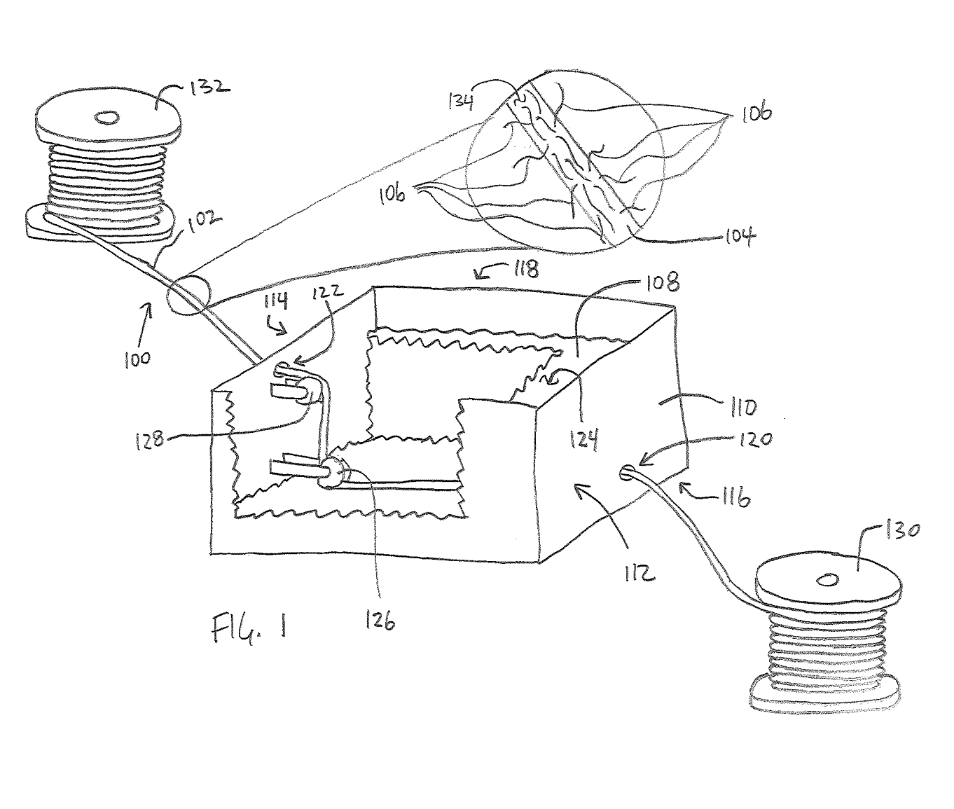

Referring to FIG. 1, a string apparatus according to one illustrative embodiment is shown generally at 100. The string apparatus 100 includes a cord, which is twine 102 in the embodiment shown. The twine 102 may be produced by spinning one or more natural fibers such as hemp, cotton, henequen, sisal, jute, and coir for example, by spinning one or more synthetic fibers, or by spinning a combination of at least one natural fiber and at least one synthetic fiber. The twine 102 is spun such that the twine 102 has a generally cylindrical core 104 of fibers, and such that some fibers have end portions that are loose such that the loose end portions (some of which are shown at 106) of such fibers extend freely away from the core 104. In alternative embodiments, instead of the twine 102, the string apparatus 100 may include one or more of various different cords such as ropes, yarns, or threads for example, which may be unitary or which may include fibers or strands that are spun, woven, braided, twisted, or kernmantle, otherwise joined in a cord. In other embodiments, the cord may or may not include loose end portions (such as those shown at 106).

The string apparatus 100 also includes diatomaceous earth 108 combined with the twine 102. In FIG. 1, an apparatus for combining the twine 102 with the diatomaceous earth 108 (to produce the string apparatus 100) includes a container 110. The container 110 has a first lateral side shown generally at 112, a second lateral side shown generally at 114 and opposite the first lateral side 112, a bottom side shown generally at 116, and a top side shown generally at 118 and opposite the bottom side 116. On the first lateral side 112, the container 110 defines a twine inlet shown generally at 120 and near the bottom side 116. On the second lateral side 114, the container 110 defines a twine outlet shown generally at 122 and near the top side 118. Between the twine inlet 120 and the twine outlet 122, the container 110 holds the diatomaceous earth 108 filled to a fill level at a top surface 124. In the embodiment shown, the top surface 124 is above the twine inlet 120 and below the twine outlet 122. Therefore, when the twine 102 enters the twine inlet 120, the twine 102 is below the top surface 124 and immersed in the diatomaceous earth 108, but when the twine 102 exits the twine outlet 122, the twine 102 is above the top surface 124 of the diatomaceous earth 108.

On the second lateral side 114, the container 110 includes a first pulley 126 and a second pulley 128 on a path between the twine inlet 120 and the twine outlet 122, and the twine 102 is positioned to be pulled from a first twine spool 130, through the twine inlet 120, over the first pulley 126, over the second pulley 128, through the twine outlet 122, and onto a second twine spool 132. The first pulley 126 has a height above the bottom of the container 110 that is similar to a height of the twine inlet 120 above the bottom of the container 110, and the second pulley 128 is generally above the first pulley 126. The second pulley 128 has a height above the bottom of the container 110 that is similar to a height of the twine outlet 122 above the bottom of the container 110. Therefore, as the twine 102 is pulled from the first twine spool 130 to the second twine spool 132, the twine 102 moves generally horizontally and through the diatomaceous earth 108 from the twine inlet 120 to the first pulley 126, generally vertically through the diatomaceous earth 108 (until the twine 102 is above the top surface 124) from the first pulley 126 to the second pulley 128, and generally horizontally above the top surface 124 from the second pulley 128 through the twine outlet 122 and onto the second twine spool 132.

In the embodiment shown, the twine 102 is drawn through the diatomaceous earth 108 in the container 110 but exits the container 110 after the second pulley 128 positions the twine 102 above the top surface 124 of the diatomaceous earth 108. Positioning the twine 102 above the top surface 124 of the diatomaceous earth 108 before the twine 102 exits the container 110 may reduce waste by reducing an amount of the diatomaceous earth 108 that exits the container 110 without being combined with the twine 102. Also, the twine inlet 120 may have a width that is close to a width of the twine 102, which may reduce waste by reducing an amount of the diatomaceous earth 108 that exits the container 110 through the twine inlet 120. However, other embodiments may include containers that differ. For example, some embodiments may omit one or both of the first pulley 126 and the second pulley 128, and some embodiments may include additional pulleys. Other embodiments may include different containers that may include one or more inlets or one or more outlets in positions different from the positions shown in FIG. 1.

In the embodiment shown in FIG. 1, the twine 102 is pulled through the diatomaceous earth 108 in the container 110, and the diatomaceous earth 108 may become coated or otherwise positioned on an exterior surface 134 of the core 104 of the twine 102. Because the twine 102 has loose end portions (such as those shown at 106) of fibers that extend freely away from the core 104, as the twine 102 is pulled through the diatomaceous earth 108, the loose end portions (such as those shown at 106) of the twine 102 may encounter the diatomaceous earth 108 more than the core 104, such that the diatomaceous earth 108 may become coated or otherwise positioned on loose end portions (such as those shown at 106) of the twine 102 in addition to any of the diatomaceous earth 108 that may become coated or otherwise positioned on an exterior surface 134 of the core 104 of the twine 102. Therefore, the loose end portions (such as those shown at 106) of the twine 102 may facilitate coating or otherwise positioning the diatomaceous earth 108 on the twine 102 to combine the diatomaceous earth 108 and the twine 102 to produce the string apparatus 100.

In other embodiments, the string apparatus 100 may be produced in other ways. For example, the string apparatus 100 of other embodiments may be produced by pulling a cord through the diatomaceous earth 108 in a container different from the container 110, or the string apparatus 100 of other embodiments may be produced by combining a cord with the diatomaceous earth 108 in other ways. For example, in other embodiments, a cord may be combined with the diatomaceous earth 108 by spraying, coating, impregnating, entraining, or otherwise placing or positioning the diatomaceous earth 108 in or on the cord. In still other embodiments, the diatomaceous earth 108 may be combined with the cord by intermixing the diatomaceous earth 108 with fibers and then spinning, weaving, braiding, or twisting the fibers, or otherwise forming the cord with the fibers, with the diatomaceous earth 108 in or on the fibers, and thus in or on the cord.

Also, in other embodiments, products other than diatomaceous earth, such as other products that may be effective to control bedbug populations or more generally as an insecticide or pesticide for example, may be intermixed with the diatomaceous earth 108. For example, U.S. Pat. No. 8,101,408 describes various legume extracts, such as one or more of PA1b-related peptides, terpenoid saponins, triterpenoid saponin, soyasaponin I, soyasaponin II, soyasaponin III, soyasaponin VI, dehydrosoyasaponin I, echinocystic acid 3-glucoside, glycyrrhizic acid, hederacoside C, beta-escin, alpha-hederin, and other acetic acid precipitated insecticidal components. In various embodiments, such legume extracts may be intermixed with the diatomaceous earth 108.

### B. Diatomaceous Earth Products

Numerous types of diatomaceous earth are available and vary, for example, on the sizes, shapes, and species of diatoms that contributed to the diatomaceous earth.

1. CELATOM™ MN-51

The diatomaceous earth 108 in some embodiments may include CELATOM™ MN-51, which is available from EP Minerals, LLC of 9785 Gateway Drive, Suite 1000, Reno, Nev., United States of America. The diatomaceous earth known as CELATOM™ MN-51 is believed to be a food-grade diatomaceous earth that originates from a deposit formed from fresh-water diatoms at Clark Station, Nev., United States of America, and that may be heat-treated or flash dried at about 900° F. (about 480° C.) or at other temperatures, for example. In one embodiment, flash drying diatomaceous earth involves heating the diatomaceous earth at about 900° F. (about 480° C.) for about 15 seconds.

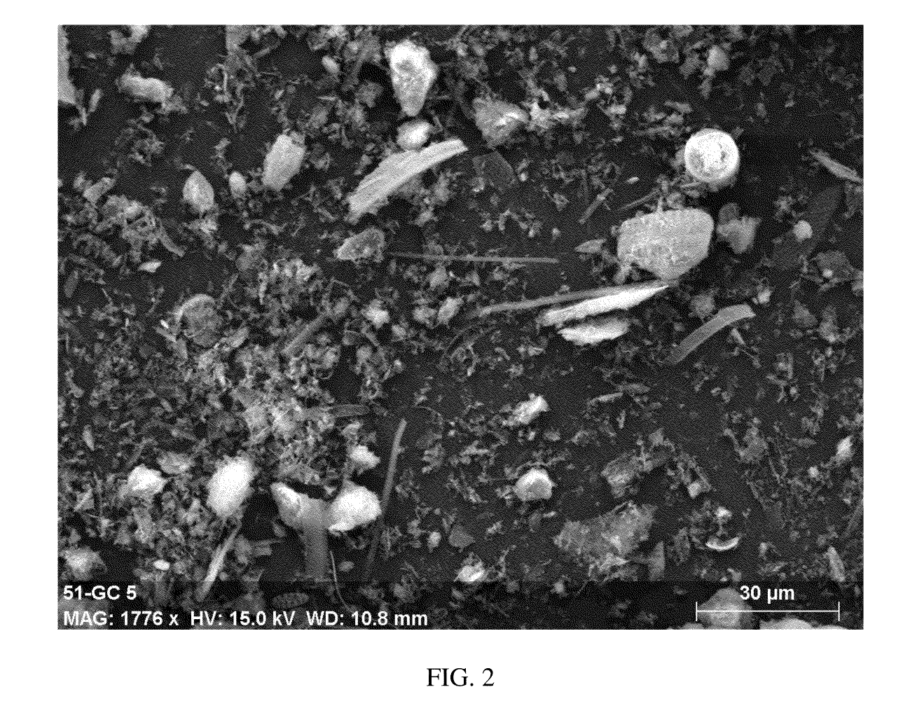

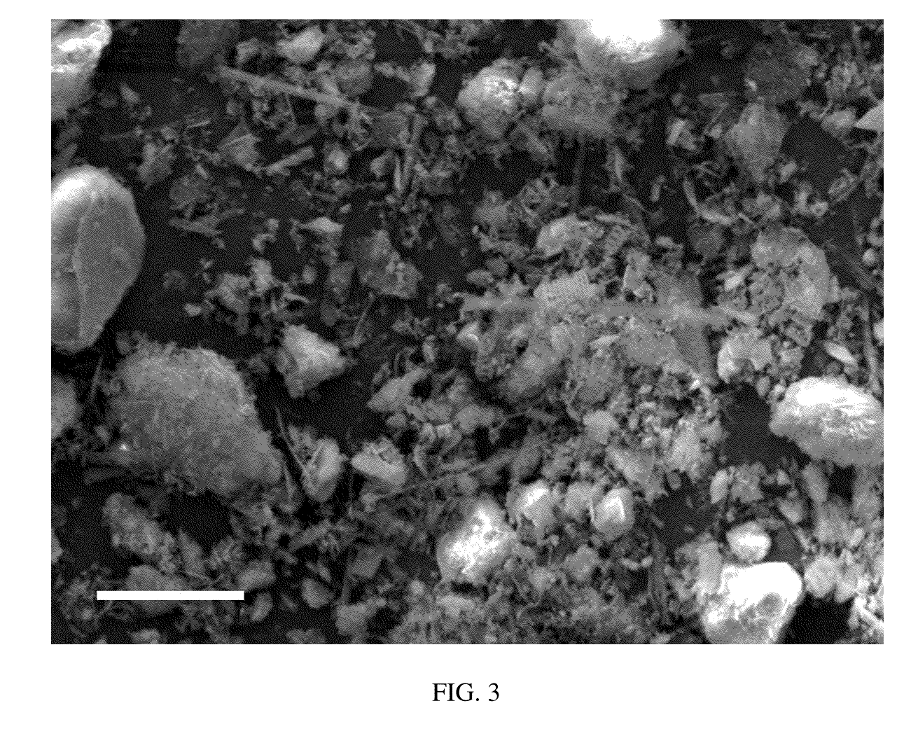

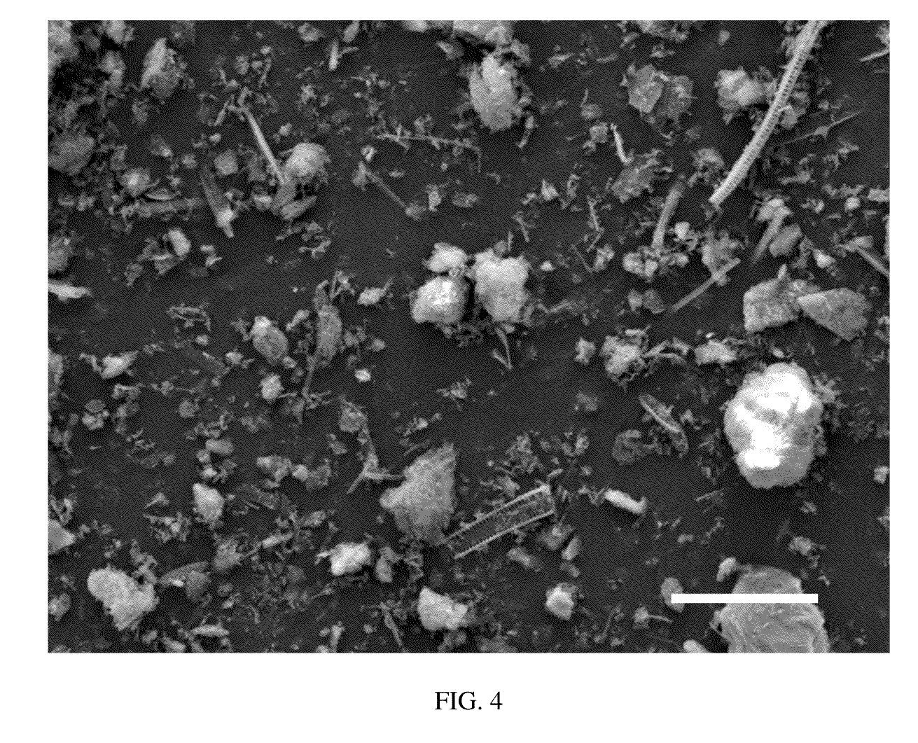

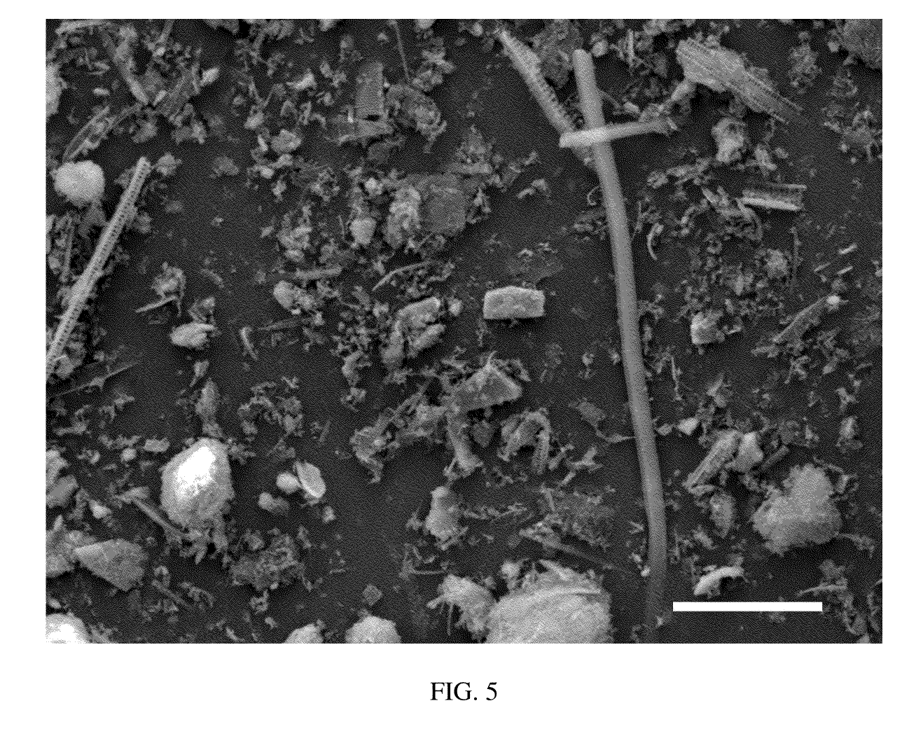

FIGS. 2 to 5 are secondary electron images (using a Philips XL-30 scanning electron microscope after coating with evaporated gold) of the diatomaceous earth known as CELATOM™ MN-51. The scale bars in FIGS. 3 to 5 represent 30 micrometers in those Figures.

The diatomaceous earth known as CELATOM™ MN-51 is believed to have the properties given in Table 1 below.

TABLE 1
Properties of CELATOM ™ MN-51.

| Structure | Natural | |
|---|---|---|
| Color | Beige | |
| G.E. Brightness | 75 | |
| Sieve Analysis (Tyler) | 6.5 | |
| % + 325 Mesh (>44 microns) | | |
| Median Particle Diameter (microns) | 15.0 | |
| pH (10% slurry) | 7.5 | |
| Free Moisture | | |
| (Maximum % H₂O) | Less than 5.0 | |
| (Typical % H₂O) | 3.0 | |
| Density | (lb/ft³) | (g/l) |
| Wet Bulk | 24 | 385 |
| Dry Bulk | 11 | 176 |

| | |
|---|---|
| Specific Gravity | 2.00 |
| Refractive Index | 1.46 |
| Oil Absorption (ASTM F 726-81) % by weight | 150 |
| Water Absorption (ASTM F 726-81) % by weight | 165 |

Chemical Analysis

| | |
|---|---|
| SiO₂ | 73.6% |
| Al₂O₃ | 7.8% |
| Fe₂O₃ | 1.8% |
| CaO | 5.6% |
| MgO | 0.3% |
| Other Oxides | 2.3% |
| Loss on Ignition | 5.5% |

A sample of the diatomaceous earth known as CELATOM™ MN-51 was reduced in size to less than 10 micrometers for quantitative X-ray analysis by grinding under ethanol in a vibratory McCrone Micronising Mill for seven minutes. Step-scan X-ray powder-diffraction data were collected over a range 3-80° 2θ with CoKa radiation on a Bruker D8 Focus Bragg-Brentano diffractometer equipped with an Fe monochromator foil, 0.6 mm (0.3°) divergence slit, incident- and diffracted-beam Soller slits, and a LynxEye detector. The long fine-focus Co X-ray tube was operated at 35 kV and 40 mA, using a take-off angle of 6°.

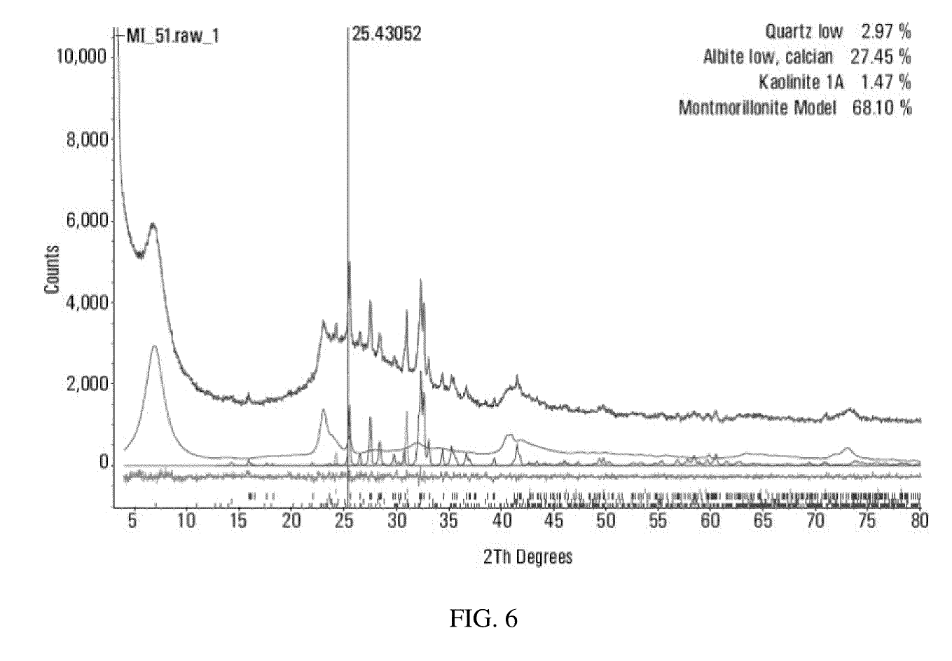

The X-ray diffractograms were analyzed using the International Centre for Diffraction Database PDF-4 and Search-Match software by Siemens (Bruker). X-ray powder-diffraction data of the sample were refined with Rietveld program Topas 4.2 (Bruker AXS). FIG. 6 is a Rietveld refinement plot of the diatomaceous earth known as CELATOM™ MN-51. FIG. 6 shows observed intensity at each step and a calculated pattern, and the line below the graph shows the difference between the observed and calculated intensities. The other lines in the graph show individual diffraction patterns of all phases, and the vertical bars represent positions of all Bragg reflections. The amounts given on FIG. 6 are renormalized amorphous-free. The sample contained abundant montmorillonite, which exhibits stacking disorder, so the crystal structure is not predictable. An empirical model was used to account for this phase. In addition, the contribution of amorphous silica was modeled with a peak phase and its amount estimated. The results may be considered semi-quantitative and are in Table 2 below.

TABLE 2
Results of phase analysis of CELATOM ™ MN-51 by
Rietveld refinements.

| | | Percent by |
|---|---|---|
| Mineral | Ideal Formula | Weight |
| Quartz | α-SiO₂ | 2 |
| Plagioclase | NaAlSi₃O₈—CaAl₂Si₂O₈ | 18 |
| Kaolinite | Al₂Si₂O₅(OH)₄ | 1 |
| Montmorillonite | (Na,Ca)_{0.3}(Al,Mg)₂Si₄O₁₀(OH)₂•nH₂O | 46 |
| Amorphous Silica | SiO₂•nH₂O | 33 |

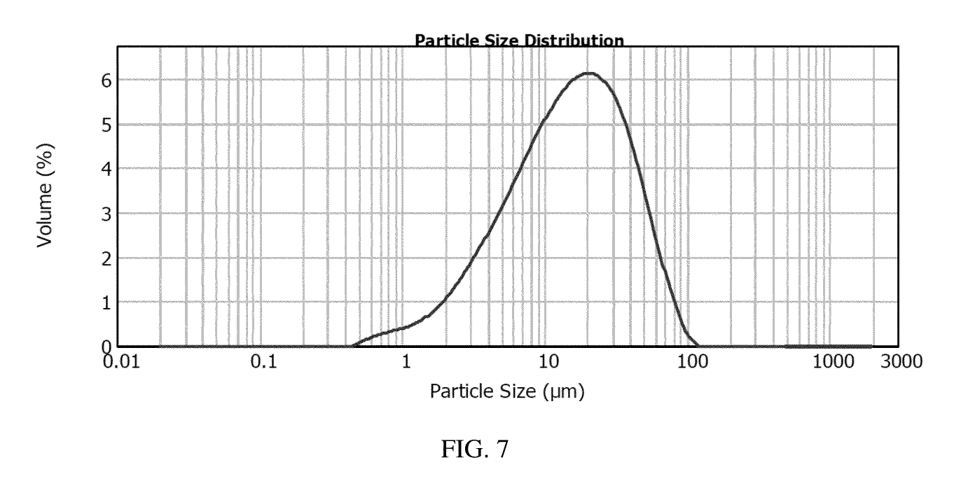

Particle sizes of sample of the diatomaceous earth known as CELATOM™ MN-51 were measured in a Mastersizer™ 2000 in a water dispersant, and FIG. 7 is a graph of particle size distribution of the diatomaceous earth known as CELATOM™ MN-51.

2. CELATOM™ MN-53

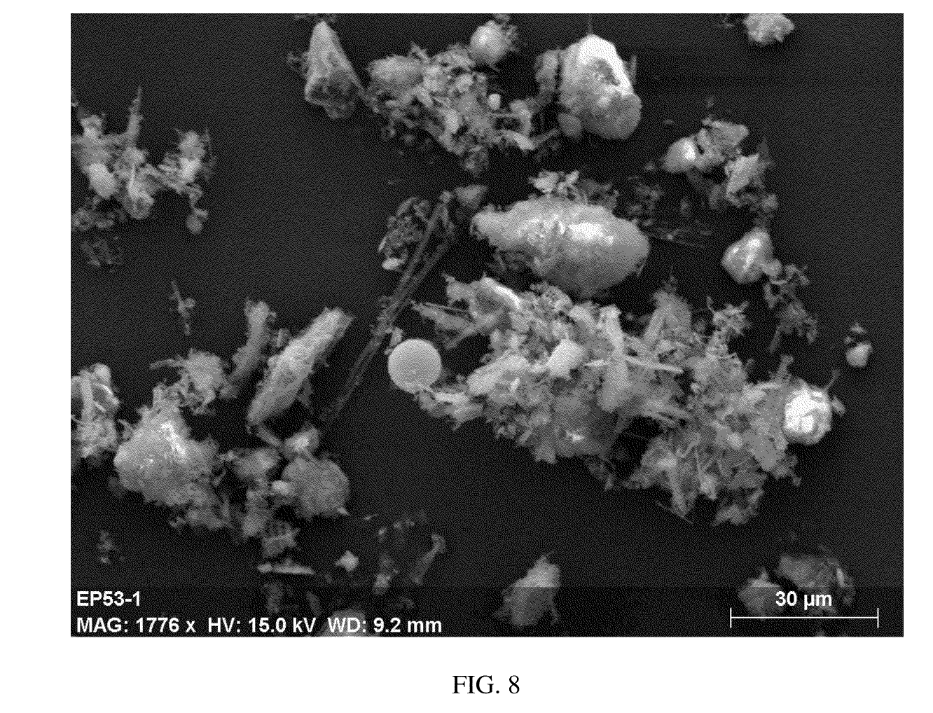

In an alternative embodiment, the diatomaceous earth may include diatomaceous earth known as CELATOM™ MN-53, which is also available from EP Minerals, LLC of 9785 Gateway Drive, Suite 1000, Reno, Nev., United States of America. FIG. 8 is a secondary electron image (using a Philips XL-30 scanning electron microscope after coating with evaporated gold) of the diatomaceous earth known as CELATOM™ MN-53. The diatomaceous earth known as CELATOM™ MN-53 is believed to have the properties given in Table 3 below.

TABLE 3
Properties of CELATOM ™ MN-53.

| Structure | Natural | |
|---|---|---|
| Color | Beige | |
| G.E. Brightness | 65 | |
| Sieve Analysis (Tyler) | 5.0 | |
| % + 325 Mesh (>44 microns) | | |
| Median Particle Diameter (microns) | 14.0 | |
| pH (10% slurry) | 7.0 | |
| Free Moisture | | |
| (Maximum % H₂O) | Less than 5.0 | |
| (Typical % H₂O) | 3.0 | |
| Density | (lb/ft³) | (g/l) |
| Wet Bulk | 31 | 500 |
| Dry Bulk | 11 | 175 |

| | |
|---|---|
| Specific Gravity | 2.00 |
| Refractive Index | 1.46 |
| Oil Absorption (ASTM F 726-81) % by weight | 150 |
| Water Absorption (ASTM F 726-81) % by weight | 165 |

Chemical Analysis

| | |
|---|---|
| SiO₂ | 83.7% |
| Al₂O₃ | 5.6% |
| Fe₂O₃ | 2.3% |
| CaO | 0.9% |
| MgO | 0.3% |
| Other Oxides | 1.9% |
| Loss on Ignition | 5.0% |

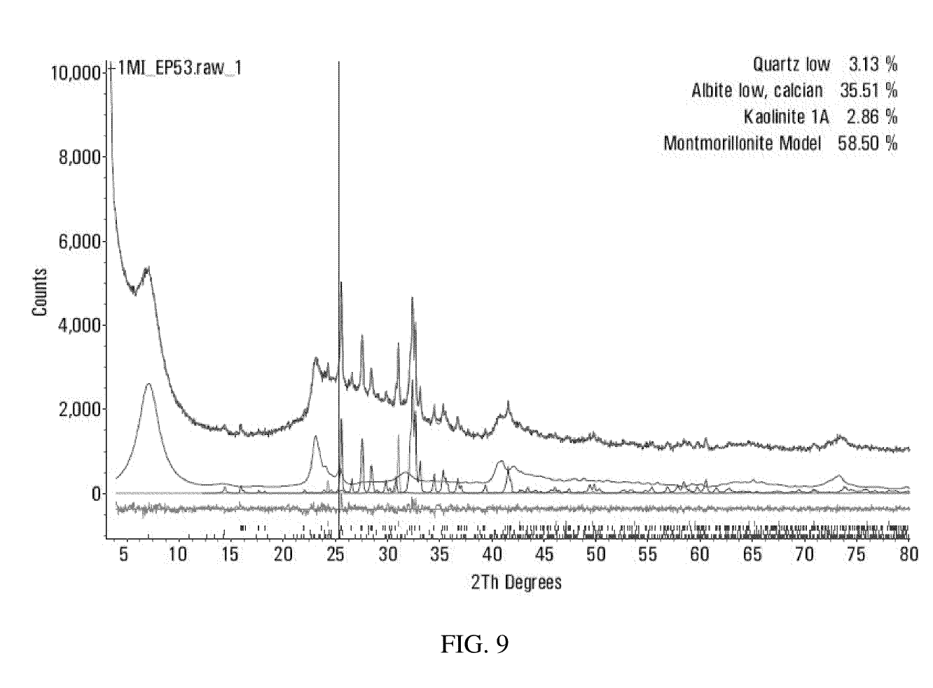

FIG. 9 is a Rietveld refinement plot of the diatomaceous earth known as CELATOM™ MN-53 obtained as described above for FIG. 6. FIG. 9 shows observed intensity at each step and a calculated pattern, and the line below the graph shows the difference between the observed and calculated intensities. The other lines in the graph show individual diffraction patterns of all phases, and the vertical bars represent positions of all Bragg reflections. The amounts given on FIG. 9 are renormalized amorphous-free. The results of phase analysis of CELATOM™ MN-53 by Rietveld refinements are in Table 4 below.

TABLE 4
Results of phase analysis of CELATOM ™ MN-53 by
Rietveld refinements.

| | | Percent by |
|---|---|---|
| Mineral | Ideal Formula | Weight |
| Quartz | α-SiO₂ | 2 |
| Plagioclase | NaAlSi₃O₈—CaAl₂Si₂O₈ | 24 |
| Kaolinite | Al₂Si₂O₅(OH)₄ | 2 |
| Montmorillonite | (Na,Ca)_{0.3}(Al,Mg)₂Si₄O₁₀(OH)₂•nH₂O | 40 |
| Amorphous Silica | SiO₂•nH₂O | 31 |

3. Alpine™ Dust

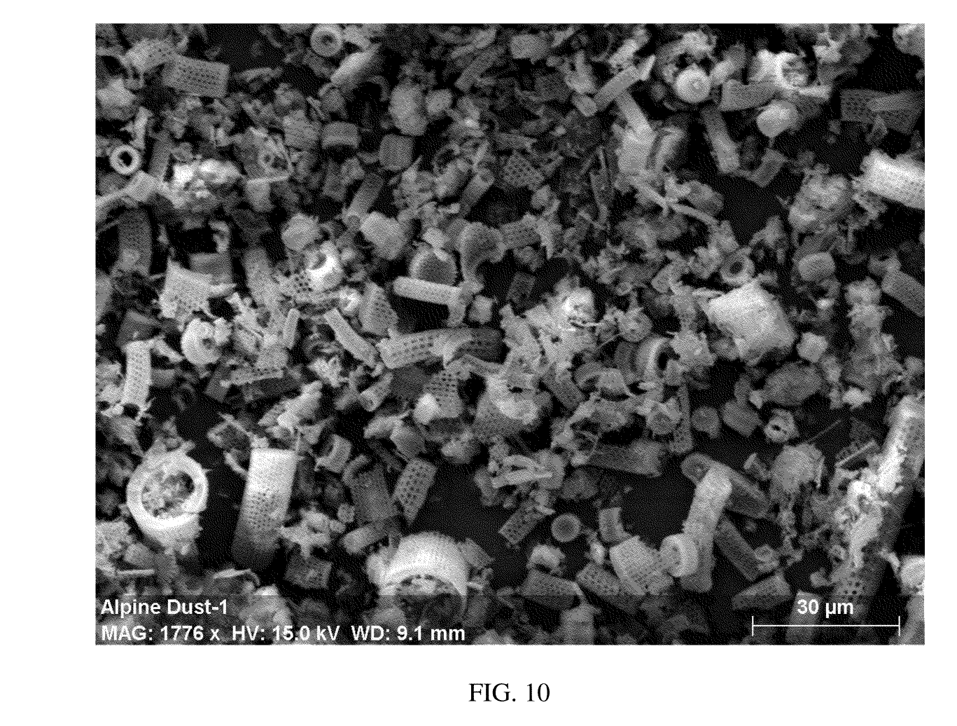

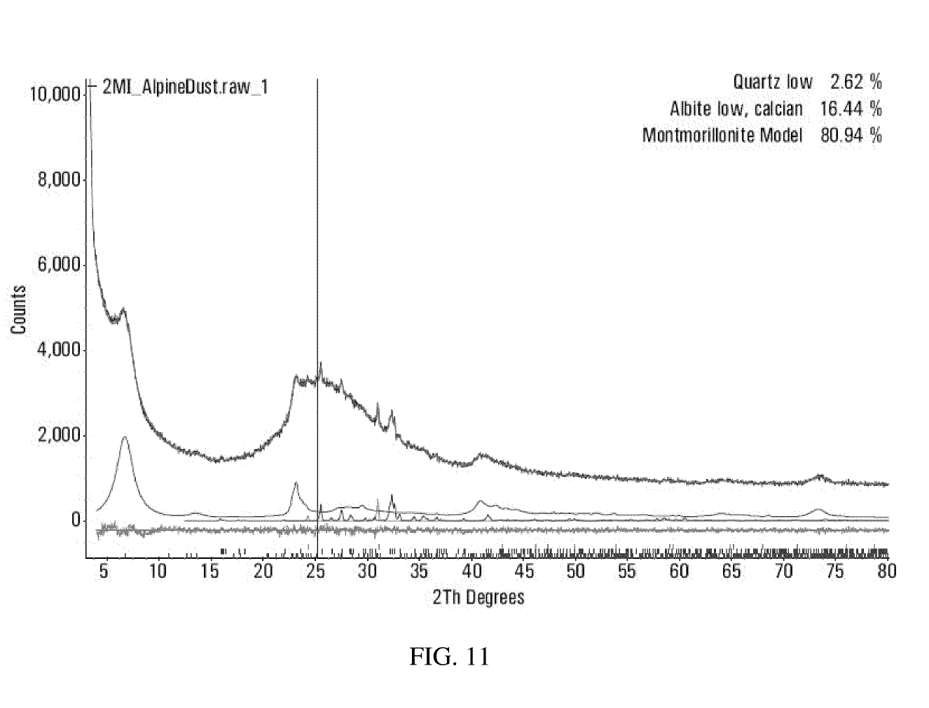

FIG. 10 is a secondary electron image (using a Philips XL-30 scanning electron microscope after coating with evaporated gold) of diatomaceous earth known as Alpine™ Dust (“Prescription Treatment Brand”) obtained from Whitmire Micro-Gen Research Laboratories, Inc. of St. Louis, Mo., United States of America, and FIG. 11 is a Rietveld refinement plot of the diatomaceous earth known as Alpine™ Dust obtained as described above for FIG. 6. FIG. 11 shows observed intensity at each step and a calculated pattern, and the line below the graph shows the difference between the observed and calculated intensities. The other lines in the graph show individual diffraction patterns of all phases, and the vertical bars represent positions of all Bragg reflections. The amounts given on FIG. 11 are renormalized amorphous-free. The results of phase analysis of Alpine™ Dust by Rietveld refinements are in Table 5 below.

TABLE 5
Results of phase analysis of Alpine ™ Dust by Rietveld refinements.

| | | Percent by |
|---|---|---|
| Mineral | Ideal Formula | Weight |
| Quartz | α-SiO₂ | 1 |
| Plagioclase | NaAlSi₃O₈—CaAl₂Si₂O₈ | 8 |
| Montmorillonite | (Na,Ca)_{0.3}(Al,Mg)₂Si₄O₁₀(OH)₂•nH₂O | 38 |
| Amorphous Silica | SiO₂•nH₂O | 53 |

4. MotherEarth™ D

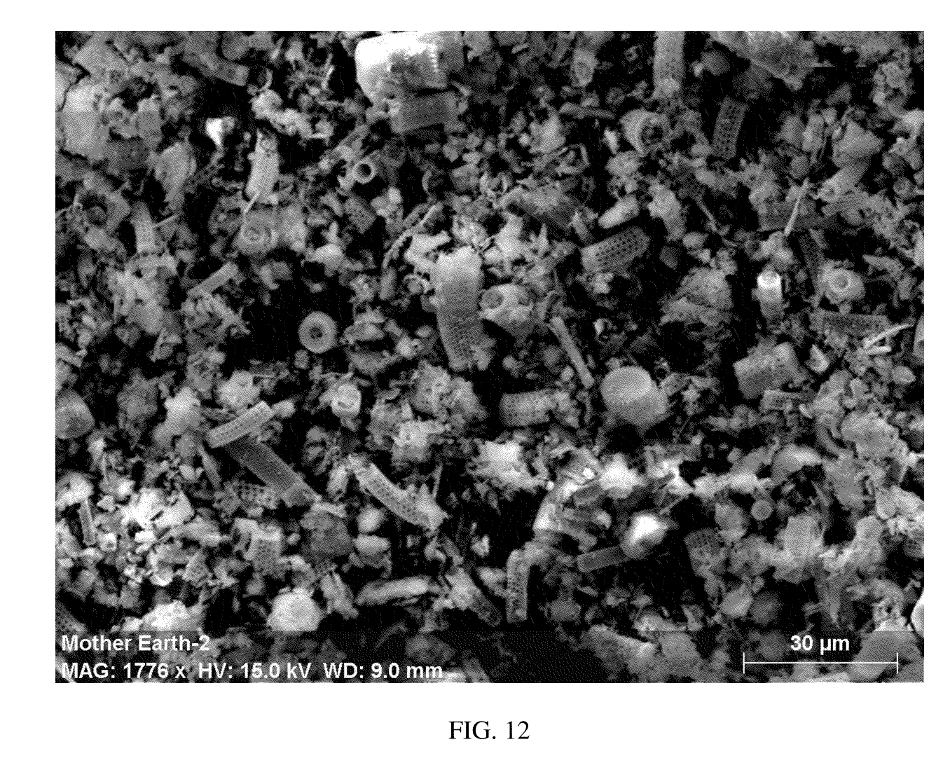

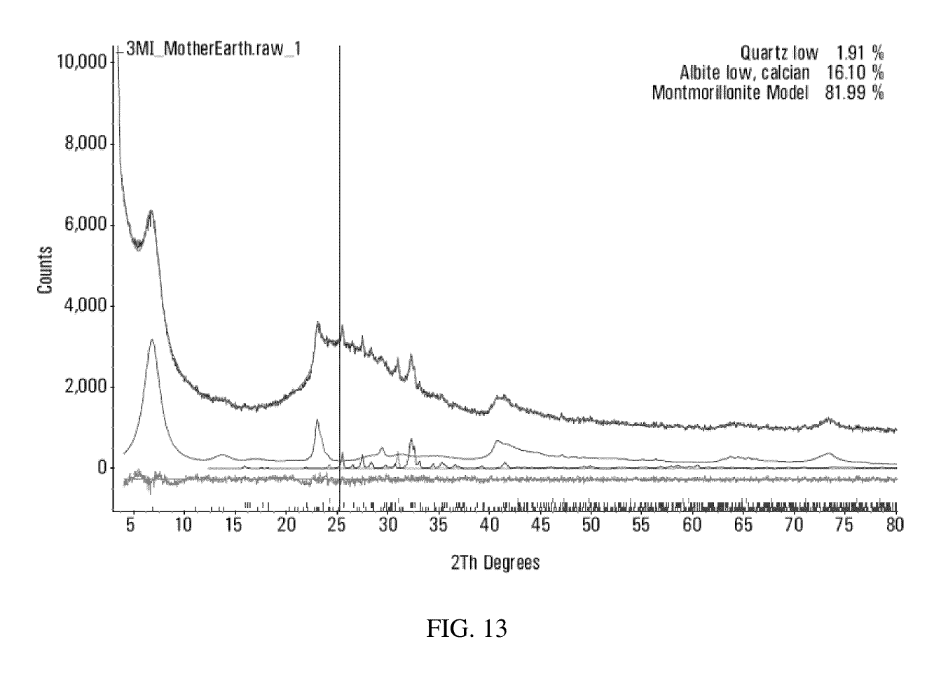

FIG. 12 is a secondary electron image (using a Philips XL-30 scanning electron microscope after coating with evaporated gold) of diatomaceous earth known as MotherEarth™ D obtained from Whitmire Micro-Gen Research Laboratories, Inc. of St. Louis, Mo., United States of America, and FIG. 13 is a Rietveld refinement plot of the diatomaceous earth known as MotherEarth™ D obtained as described above for FIG. 6. FIG. 13 shows observed intensity at each step and a calculated pattern, and the line below the graph shows the difference between the observed and calculated intensities. The other lines in the graph show individual diffraction patterns of all phases, and the vertical bars represent positions of all Bragg reflections. The amounts given on FIG. 13 are renormalized amorphous-free. The results of phase analysis of MotherEarth™ D by Rietveld refinements are in Table 6 below.

TABLE 6
Results of phase analysis of MotherEarth ™ D by Rietveld refinements.

| | | Percent by |
|---|---|---|
| Mineral | Ideal Formula | Weight |
| Quartz | α-SiO₂ | 1 |
| Plagioclase | NaAlSi₃O₈—CaAl₂Si₂O₈ | 9 |
| Montmorillonite | (Na,Ca)_{0.3}(Al,Mg)₂Si₄O₁₀(OH)₂•nH₂O | 47 |
| Amorphous Silica | SiO₂•nH₂O | 43 |

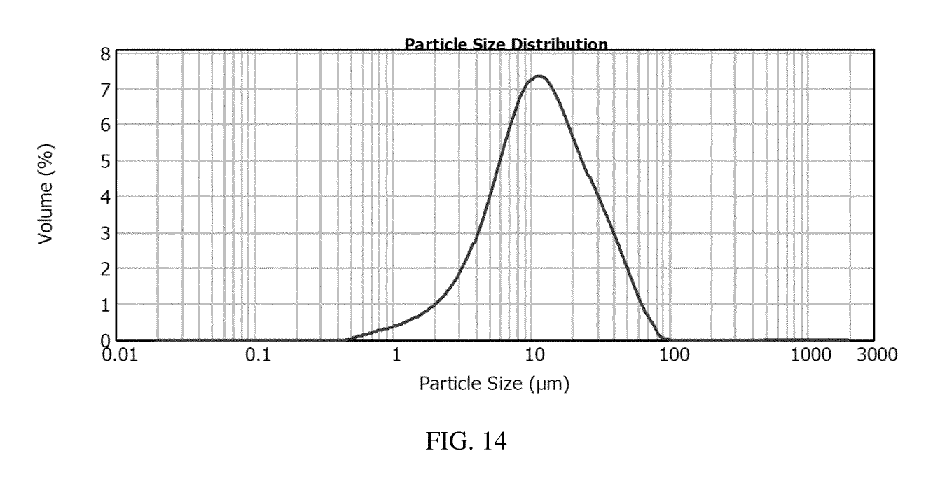

Particle sizes of sample of the diatomaceous earth known as MotherEarth™ D were measured in a Mastersizer™ 2000 in a water dispersant, and FIG. 14 is a graph of particle size distribution of the diatomaceous earth known as MotherEarth™ D.

5. PRO-ACTIVE™

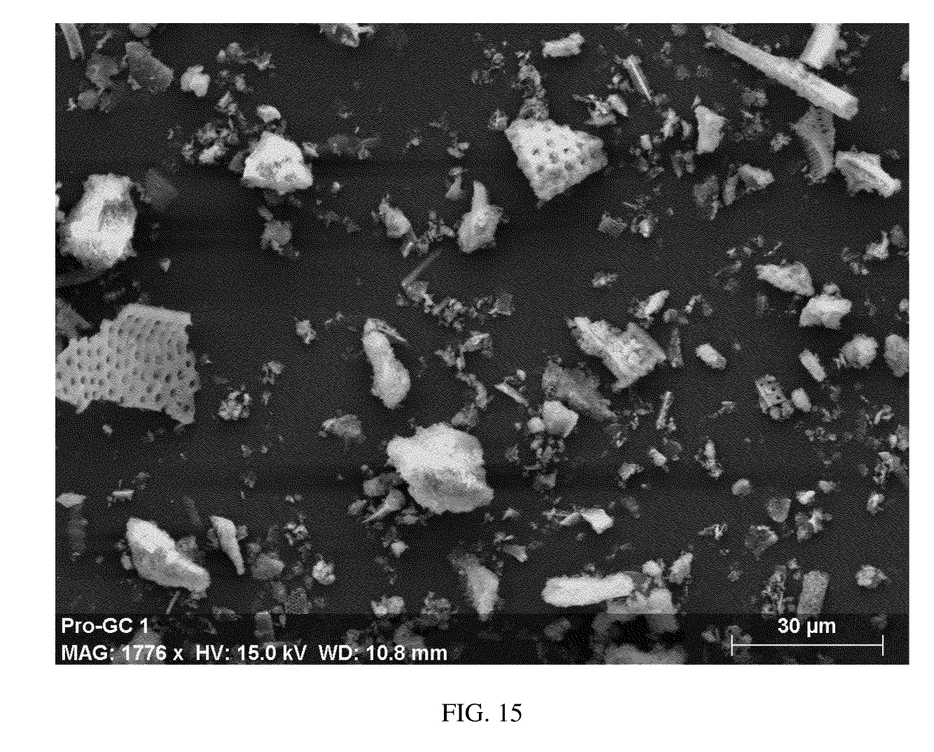

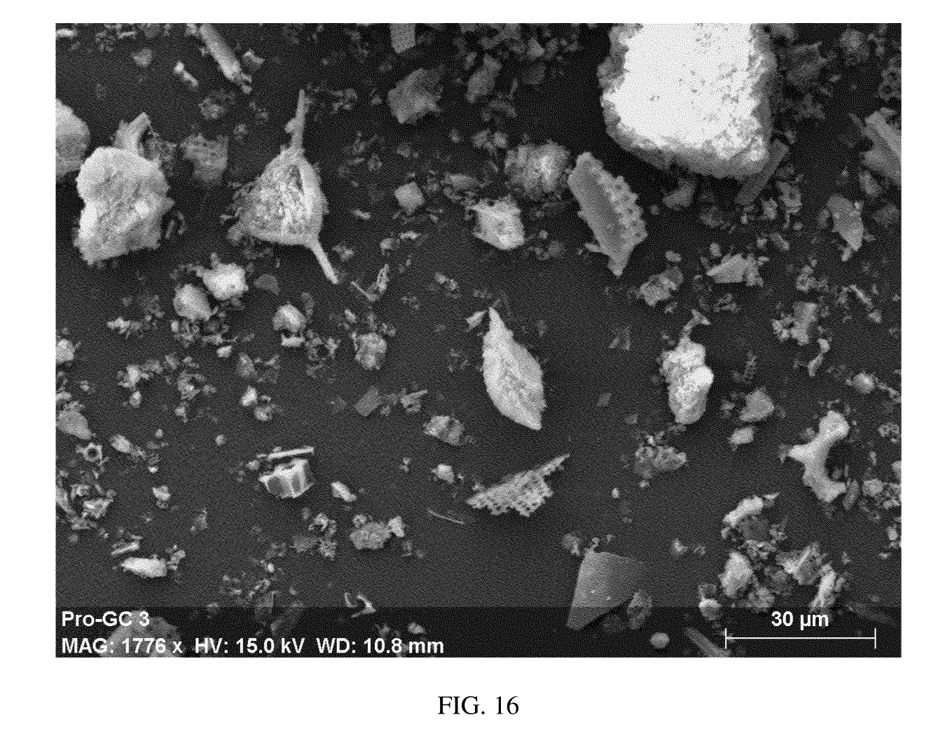

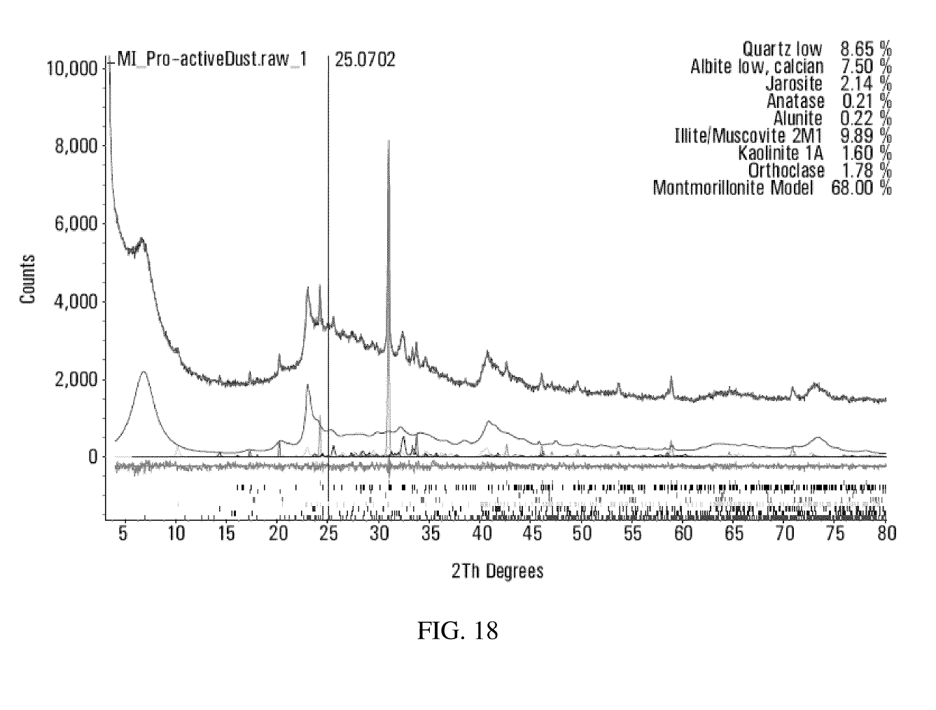

FIGS. 15 to 17 are secondary electron images (using a Philips XL-30 scanning electron microscope after coating with evaporated gold) of diatomaceous earth known as PRO-ACTIVE™ obtained from Pest Control Direct Ltd., Hailsham, East Sussex, United Kingdom, and FIG. 18 is a Rietveld refinement plot of the diatomaceous earth known as PRO-ACTIVE™ obtained as described above for FIG. 6. FIG. 18 shows observed intensity at each step and a calculated pattern, and the line below the graph shows the difference between the observed and calculated intensities. The other lines in the graph show individual diffraction patterns of all phases, and the vertical bars represent positions of all Bragg reflections. The amounts given on FIG. 18 are renormalized amorphous-free. The results of phase analysis of PRO-ACTIVE™ by Rietveld refinements are in Table 7 below.

TABLE 7
Results of phase analysis of PRO-ACTIVE ™ by Rietveld refinements.

| | | Percent by |
|---|---|---|
| Mineral | Ideal Formula | Weight |
| Quartz | α-SiO₂ | 6 |
| Plagioclase | NaAlSi₃O₈—CaAl₂Si₂O₈ | 5 |
| Alunite | K₂Al₆(SO₄)₄(OH)₁₂ | <1 |
| Jarosite | K₂Fe₆³⁺(SO₄)₄(OH)₁₂ | 2 |
| Anatase | TiO₂ | <1 |
| K-feldspar | KAlSi₃O₈ | 1 |
| Illite/Muscovite | K_{0.65}Al_{2.0}Al_{0.65}Si_{3.35}O₁₀(OH)₂ | 7 |
| Kaolinite | Al₂Si₂O₅(OH)₄ | 1 |
| Montmorillonite | (Na,Ca)_{0.3}(Al,Mg)₂Si₄O₁₀(OH)₂•nH₂O | 50 |
| Amorphous Silica | SiO₂•nH₂O | 27 |

### C. Experiments

Experiment #1

In one experiment (“Experiment #1”), small plastic Petri dishes available from Gelman Sciences™, each about 5.0 cm or about 2.0 inches in diameter, were used in bioassays. A small opening of about 1.5 cm (or about 0.6 inches) in diameter was cut in the lid and closed with a piece of gauze to allow air for bedbug breathing. The Petri dishes were lined with a filter paper about 4.25 cm (or about 1.7 inches) in diameter. Diatomaceous earth was weighed and spread uniformly over the filter paper with forceps. Ten adult field-collected common bedbugs (Cimex lectularius) were introduced in each of the Petri dishes, and the lids were placed over them to prevent their escape. Petri dishes were transferred in a plastic box lined with paper towels sprayed with water to maintain humidity in the box. Experiments were conducted at room temperature, and mortality was noted 24, 48, 72, and 96 hours after the bedbugs were introduced into of the Petri dishes. Four concentrations, between about 0.5 milligrams (“mg”) and about 2.0 mg, were used to calculate a lowest lethal concentration sufficient to kill 50% of the bedbugs (“LC₅₀”) of each product. There was a single replication of 10 bedbugs each.

Tables 8 and 9 below show mortality data from Experiment #1, where “L” refers to a number of bedbugs still living after a corresponding time given in the tables, and where “D” refers to a number that died after the time given.

TABLE 8
Toxicity of adult bedbugs to CELATOM ™ MN-51.

| | Amount of CELATOM ™ MN-51 | | | | | | | |
|---|---|---|---|---|---|---|---|---|
| | 2.0 mg | | 1.0 mg | | 0.8 mg | | 0.5 mg | |
| Time (hours) | L | D | L | D | L | D | L | D |
| 48 | 0 | 10 | 3 | 7 | 4 | 6 | 5 | 5 |
| 72 | | | 0 | 3 | 0 | 4 | 0 | 5 |

TABLE 9
Toxicity of adult bedbugs to CELATOM ™ MN-53.

| | Amount of CELATOM ™ MN-53 | | | | | | | |
|---|---|---|---|---|---|---|---|---|
| | 2.0 mg | | 1.0 mg | | 0.8 mg | | 0.5 mg | |
| Time (hours) | L | D | L | D | L | D | L | D |
| 48 | 6 | 4 | 9 | 1 | 7 | 3 | 8 | 2 |
| 72 | 6 | 4 | 9 | 1 | 7 | 3 | 8 | 2 |
| 96 | 0 | 10 | 4 | 6 | 6 | 4 | 7 | 3 |

All of the bedbugs died in CELATOM™ MN-51 diatomaceous earth after 48 hours. Therefore, LC₅₀ for CELATOM™ MN-51 was calculated for 48 hours only, and LC₅₀ after 48 hours for CELATOM™ MN-51 was calculated as 0.7 mg. The data after 48 hours for CELATOM™ MN-53 were not good for calculation, and therefore LC₅₀ for CELATOM™ MN-53 was calculated after 96 hours as 0.8 mg (0.552-1.052).

Experiment #2

In another experiment (“Experiment #2”), mortality of CELATOM™ MN-51 was compared with the diatomaceous earth products known as Alpine™ Dust, MotherEarth™ D, and PRO-ACTIVE™. The various products were applied with forceps and weighed on a small filter paper, which was then placed in a Petri dish (about 5.0 cm or about 2 inches diameter). Common bedbugs (Cimex lectularius) were introduced in the various Petri dishes, and mortality was assessed in each of the Petri dishes after 24 hours and after 48 hours. Four to five concentrations of each product were used, the concentrations ranging from 0.25 mg to 6 mg, and there were three replications of between 9 and 11 bedbugs (adults or last instar nymphs) in each replication. A probit analysis was used to calculate LC₅₀ and LC₉₅ (lowest lethal concentrations sufficient to kill 95% of the bedbugs) values and 95% confidence intervals (“CIs”) for the LC₅₀ and LC₉₅ values, as shown in Table 10 below.

TABLE 10
LC₅₀, LC₉₅, and CI for CELATOM ™ MN-51, Alpine ™ Dust, and
MotherEarth ™ D.

| | Time | LC₅₀ | CI of LC₅₀ | LC₉₅ | CI of |
|---|---|---|---|---|---|
| Product | (hours) | (mg) | (mg) | (mg) | LC₉₅ (mg) |
| CELATOM ™ | 24 | 0.24 | 0.1-0.32 | 0.95 | 0.69-1.98 |
| MN-51 | | | | | |
| Alpine ™ Dust | 24 | 6.36 | 3.83-29.27 | 52.57 | 15.88-3366 |
| Alpine ™ Dust | 48 | 1.72 | 1.37-2.18 | 6.6 | 4.47-13.44 |
| MotherEarth ™ D | 24 | 0.26 | 0.14-0.36 | 1.37 | 0.91-3.44 |
| PRO-ACTIVE ™ | 24 | 3.2 | 2.28-5.34 | 28.8 | 12.8-192.4 |

Experiment #3

In another experiment (“Experiment #3”), six Petri dishes (each about 5.0 cm or about 2.0 inches in diameter) were sprayed with an aerosol including CELATOM™ MN-51 using an apparatus similar to the spray apparatus described in U.S. patent application Ser. No. 14/222,335, and a thin coating of the CELATOM™ MN-51 remained after drying; those six Petri dishes were used for an experimental group. An additional six Petri dishes (each 5.0 cm or about 2.0 inches in diameter) did not receive the aerosol or the diatomaceous earth; those six Petri dishes were used for a control group. Five adult common bedbugs (Cimex lectularius) were introduced with forceps into each of the 12 Petri dishes, and lids were applied to prevent the bedbugs from escaping. Mortality was assessed 3, 15, 18, and 24 hours after the bedbugs were introduced into the Petri dishes, and there was no mortality in the control group. Mortality in the experimental group is shown in Table 11 below.

TABLE 11
Number of bedbugs dead from aerosol including CELATOM ™ MN-51.

| Petri | Number | | | |
|---|---|---|---|---|
| dish | dead | Number dead | Number dead | Number dead |
| number | after 3 hours | after 15 hours | after 18 hours | after 24 hours |
| 1 | 0 | 5 | 5 | 5 |
| 2 | 0 | 2 | 3 | 5 |
| 3 | 0 | 5 | 5 | 5 |
| 4 | 0 | 4 | 5 | 5 |
| 5 | 0 | 5 | 5 | 5 |
| 6 | 0 | 3 | 3 | 5 |
| Total | 0 | 24 | 26 | 30 |

Thus, in Experiment #3, all of the bedbugs exposed to the aerosol including CELATOM™ MN-51 died within 24 hours, whereas none of the control group bedbugs died within 24 hours.

Experiment #4

Another experiment (“Experiment #4”) involved plastic RUBBERMAID™ translucent boxes (about 73.6 cm×about 45.7 cm×about 33.7 cm, or about 29 inches×about 18 inches×about 13.3 inches), more particularly two such boxes as experimental boxes and two such boxes as control boxes. A section about 20 cm (or about 7.9 inches) wide in the center of each of the experimental boxes was sprayed with the aerosol including CELATOM™ MN-51 and allowed to dry. A piece of a field-collected sheet (about 50 cm×about 24 cm, or about 19.7 inches×about 7.9 inches) was lined on one side of each of the boxes and used as a stimulant. The sheet was collected from a home infested with bedbugs, and had eggs and many freshly fed bedbugs, but the bedbugs were collected from the sheet before placing pieces of the sheet into the boxes. Sides of the boxes opposite the pieces of the field-collected sheet were lined with a clean and new piece of cloth. Fifty adult common bedbugs (Cimex lectularius) were introduced into each box on the clean cloth, and then the box was closed with a lid. The control boxes were similar to the experimental boxes but did not include the aerosol.

In all four of the boxes, the bedbugs moved from the sides of the boxes having the clean cloths to the sides of the boxes having the pieces of the field-collected sheet. There was no mortality in the control boxes after 48 hours, but after 24 hours, one of the experimental boxes had mortality of 43 of the 50 bedbugs, and the other of the experimental boxes had mortality of 45 of the 50 bedbugs. All of the bedbugs in the experimental boxes died after 48 hours. The bedbugs were found dead lying on their backs and dusted with the product from the aerosol.

Experiment #5

Another experiment (“Experiment #5”) was the same as Experiment #4 except that 100 common bedbugs (Cimex lectularius) were introduced on the clean piece of cloth as described for Experiment #4. Insects again moved from one side of the box to the other in all cases. There was no mortality in the control boxes, whereas after 18 hours, 99 bedbugs died in one of the experimental boxes and 98 bedbugs died in the other one of the experimental boxes. All of the bedbugs in both experimental boxes died after 24 hours.

Experiment #6

In one experiment (Experiment #6), 1.5 mg of diatomaceous earth was placed on a piece of filter paper. One adult common bedbug (Cimex lectularius) (the “treaded bedbug”) was dusted by introducing it on the filter paper using forceps. The treated bedbug was then introduced in a Petri dish (about 5.0 cm or about 2.0 inches in diameter) containing 4 untreated adult common bedbugs (Cimex lectularius). Both CELATOM™ MN-51 and MotherEarth™ D diatomaceous earths were tested using this method. Control Petri dishes contained five bedbugs, none of which was dusted with diatomaceous earth. There were six replications with five bedbugs in each. Petri dishes were placed in a plastic box with a lid, and mortality was assessed after 24 hours, 48 hours, and 96 hours. Table 12 below shows the number of bedbugs dead in each of the six replications for CELATOM™ MN-51, MotherEarth™ D, and control Petri dishes after 24 hours, 48 hours, and 96 hours.

TABLE 12
Number of bedbugs dead for CELATOM ™ MN-51 (“51”),
MotherEarth ™ D (“ME”), and control (“C”) Petri dishes.

| | Number | | | Number | | | Number | | |
|---|---|---|---|---|---|---|---|---|---|
| | Dead After | | | Dead After | | | Dead After | | |
| Petri | 24 Hours | | | 48 Hours | | | 96 Hours | | |
| Dish | 51 | ME | C | 51 | ME | C | 51 | ME | C |
| 1 | 0 | 0 | 0 | 0 | 0 | 0 | 2 | 3 | 2 |
| 2 | 0 | 0 | 0 | 0 | 0 | 0 | 5 | 1 | 3 |
| 3 | 0 | 0 | 0 | 0 | 0 | 0 | 4 | 5 | 1 |
| 4 | 0 | 0 | 0 | 0 | 0 | 0 | 4 | 4 | 1 |
| 5 | 0 | 0 | 0 | 0 | 0 | 0 | 4 | 1 | 1 |
| 6 | 1 | 0 | 0 | 1 | 0 | 0 | 4 | 2 | 0 |
| Total | 1 | 0 | 0 | 1 | 0 | 0 | 23 | 16 | 8 |

Experiment #7

In another experiment (Experiment #7), 2.0 mg of either CELATOM™ MN-51 or MotherEarth™ D diatomaceous earth was mixed with a red fluorescent dust from a luminous powder kit #1162A obtained from BioQuip Products Inc., Rancho Dominguez, Calif., United States of America and placed on a piece of filter paper. One adult common bedbug (Cimex lectularius) was dusted by introducing it on the filter paper using forceps. The dusted bedbug was then introduced in a Petri dish (about 5.0 cm or about 2.0 inches in diameter) containing 4 untreated adult common bedbugs (Cimex lectularius). All Petri dishes were then placed in a plastic box with a lid. Control Petri dishes contained five adult common bedbugs (Cimex lectularius), none of which has been dusted with diatomaceous earth. There were three replications of each condition, and mortality was assessed after 16 hours. The mortality data are shown in Table 13 below.

TABLE 13
Number of bedbugs dead after 16 hours for CELATOM ™ MN-51,
MotherEarth ™ D, and control Petri dishes.

| Petri Dish | CELATOM ™ MN-51 | MotherEarth ™ D | Control |
|---|---|---|---|
| 1 | 3 | 1 | 0 |
| 2 | 4 | 3 | 0 |
| 3 | 4 | 2 | 0 |
| Total | 11 (61.1%) | 6 (33.3%) | 0 |

The fluorescent dye was visibly observed on the bedbugs that did not contact the diatomaceous earth directly, suggesting that such bedbugs came into contact with diatomaceous earth by contacting the bedbug that had contacted the diatomaceous earth directly.

Experiment #8

In another experiment (“Experiment #8”), diatomaceous earth dusts were weighed on filter paper (Fisher™ brand, about 5.5 cm or about 2.2 inches in diameter). The filter papers were shaken about 3 or 4 times to remove excess dust and were weighed again to measure diatomaceous earth remaining on the paper. Table 14 below shows the weight of dust before shaking, the weight of dust remaining after shaking, and the amount lost from shaking as the difference between the weight of dust before shaking and the weight of dust after shaking.

TABLE 14
Weights of dust before shaking, after shaking, and amounts
lost from shaking.

| Product Applied | Weight before | Weight after | Amount Lost from |
|---|---|---|---|
| as Dust | Shaking (mg) | Shaking (mg) | Shaking (mg) |
| PRO-ACTIVE ™ | 5 | 1.8 | 3.2 |
| | 5.3 | 2.7 | 2.6 |
| | 6 | 3.1 | 2.9 |
| mean | 5.4 | 2.5 | 2.9 |
| Alpine ™ Dust | 6.6 | 3.9 | 2.7 |
| | 5.3 | 3.2 | 2.1 |
| | 5.5 | 3.5 | 2 |
| mean | 5.8 | 3.5 | 2.3 |
| MotherEarth ™ | 6.5 | 3.4 | 3.1 |
| D | 6.5 | 4.3 | 2.2 |
| | 6.8 | 3.7 | 3.1 |
| mean | 6.6 | 3.8 | 2.8 |

Similarly, filter paper was weighed, sprayed with aerosol, dried, and weighed again to measure the diatomaceous earth residue. There were three replications for each diatomaceous earth sample tested. Table 15 below shows weights of filter paper before and after spraying aerosol with diatomaceous earth, and amounts of diatomaceous earth added from spraying.

TABLE 15
Weights of filter paper before and after spraying aerosol, and amounts of
diatomaceous earth added from spraying.

| | | | Amount |
|---|---|---|---|
| Product Applied | Weight before | Weight after | Added from |
| in Aerosol Spray | Spraying (mg) | Spraying (mg) | Spraying (mg) |
| CELATOM ™ MN- | 164 | 175 | 11 |
| 51 | 157.4 | 173 | 15.6 |
| | 162 | 176 | 14 |
| mean | 161.1 | 174.7 | 13.5 |
| CELATOM ™ MN- | 151.1 | 152.8 | 1.7 |
| 51 (in reduced | 169.4 | 175.8 | 6.4 |
| spraying volume) | 162 | 170 | 8 |
| mean | 160.8 | 166.2 | 5.4 |

Experiment #9

In another experiment (“Experiment #9”), a sample of CELATOM™ MN-51 was size-separated to separate into a smaller size fraction of particles less than about 11 micrometers in size and into a larger size fraction of particles larger than about 11 micrometers in size. The CELATOM™ MN-51 sample was size separated in a centrifuge, and because some particles of CELATOM™ MN-51 are non-spherical, 11 micrometers is an approximate separation size and, for example, the smaller size fraction may include elongate particles that are longer than 11 micrometers. In general herein, “a smaller size fraction of particles less than about 11 micrometers in size” may in some embodiments include a smaller size fraction from centrifugal size separation that may include elongate particles that are longer than 11 micrometers.

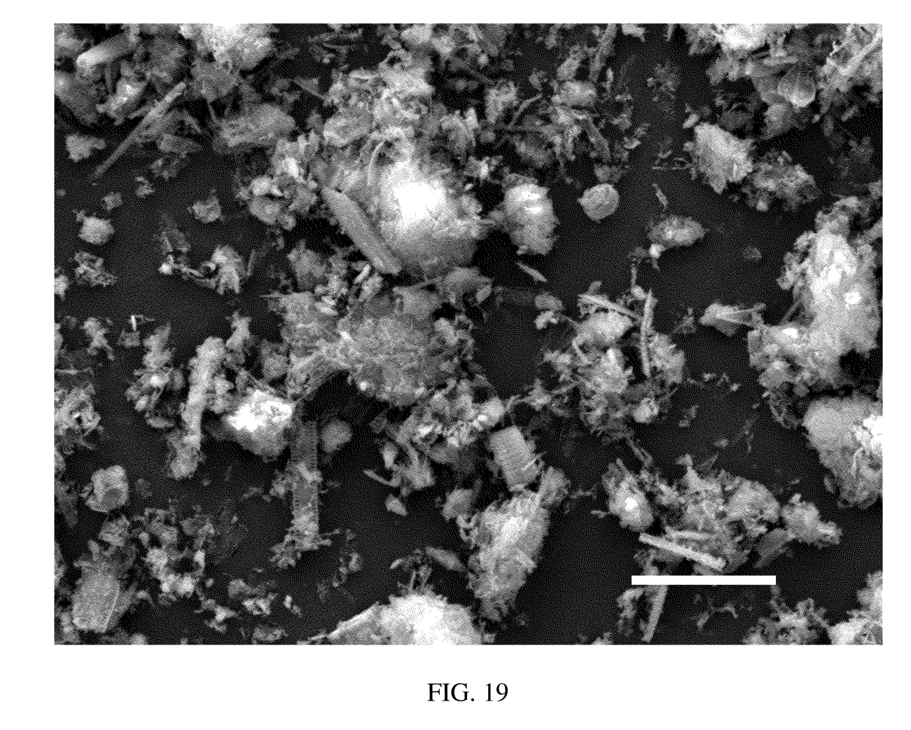

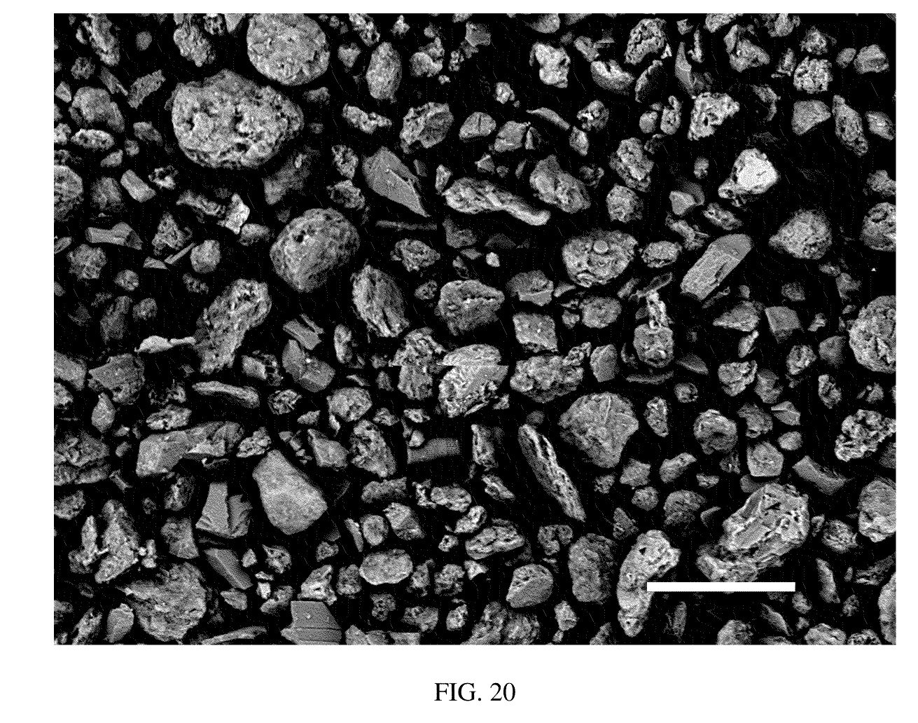

The size-separated powders were examined using a Philips XL-30 scanning electron microscope after coating with evaporated gold. FIG. 19 is a scanning electron microscope image of the smaller size fraction (particles less than about 11 micrometers in size) and FIG. 20 is a scanning electron microscope image of the larger size fraction (particles larger than about 11 micrometers in size). The scale bar in FIG. 19 represents 30 micrometers, whereas the scale bar in FIG. 20 represents 120 micrometers. The original sample of CELATOM™ MN-51 was reduced in weight by about 30% after the larger size fraction (particles larger than about 11 micrometers in size) was removed from it.

Efficacy against bedbugs of the smaller size fraction of CELATOM™ MN-51 and of the larger size fraction of CELATOM™ MN-51 was measured in three replications of eight adult common bedbugs (Cimex lectularius) each, for a total of 24 bedbugs introduced. Samples were weighed and spread on filter papers in Petri dishes, and the bedbugs were then introduced. Mortality assessed after 24 hours and after 48 hours. Table 16 below shows the number of the initially introduced 24 bedbugs that were killed after 24 and after 48 hours when exposed to 1, 2, 4, and 8 mg of the smaller size fraction of CELATOM™ MN-51 and of the larger size fraction of CELATOM™ MN-51.

TABLE 16
Recorded mortality for size-separated CELATOM ™ MN-51 and
unseparated CELATOM ™ MN-51.

| | | | Larger Size Fraction of | |
|---|---|---|---|---|
| | Smaller Size Fraction of | | CELATOM ™ MN-51 | |
| | CELATOM ™ MN-51 | | | Number |
| Amount | Number killed | Number killed | Number killed | killed after |
| (mg) | after 24 hours | after 48 hours | after 24 hours | 48 hours |
| 1 | 8 | 20 | 0 | 0 |
| 2 | 10 | 21 | 1 | 1 |
| 4 | 14 | 22 | 2 | 2 |
| 8 | 15 | 24 | 3 | 3 |

From the data above, LC₅₀ may be calculated as shown in Table 17 below. Table 17 also shows confidence intervals of LC₅₀ in brackets where the confidence intervals were also calculated.

TABLE 17
LC₅₀ for size-separated CELATOM ™ MN-51.

| | LC₅₀ after 24 | LC₅₀ after 48 |
|---|---|---|
| Sample | hours (mg) | hours (mg) |
| Smaller Size Fraction of | 3.038 | 0.201 |
| CELATOM ™ MN-51 | (0.983-13.803) | (0.000-0.688) |
| Larger Size Fraction of | 50.221 | 50.221 |
| CELATOM ™ MN-51 | | |

Experiment #10

In another experiment (“Experiment #10”), silverfish (Lepisma saccharina, Lepismatidae, Thysanura) were collected from the basement of the MacMillan building at The University of British Columbia (“UBC”) in British Columbia, Canada. In an experimental group, about 20 mg of CELATOM™ MN-51 dust was weighed in each of three polystyrene 50 mm×9 mm Petri dishes (from Pall Life Sciences), and five silverfish (males and females, adults and nymphs) were introduced to each of the three Petri dishes. In a control group, five silverfish (males and females, adults and nymphs) were introduced to each of three Petri dishes with no CELATOM™ MN-51 dust. Lids were added to the Petri dishes to prevent the silverfish from escaping.

Mortality was assessed after 24 hours, 48 hours, and 72 hours. The mortality data are shown in Table 18 below, where “L” refers to a number of silverfish still living after a corresponding time given in the tables, and where “D” refers to a number that died after the time given.

TABLE 18
Contact toxicity of CELATOM ™ MN-51 aerosol against
Lepisma saccharina.

| | | | | | | | Control | |
|---|---|---|---|---|---|---|---|---|
| | Experimental Group | | | | | | Group | |
| Petri Dish | 24 Hours | | 48 Hours | | 72 Hours | | 72 Hours | |
| Number: | L | D | L | D | L | D | L | D |
| 1 | 2 | 3 | 1 | 4 | 0 | 5 | 5 | 0 |
| 2 | 1 | 4 | 0 | 5 | 0 | 5 | 5 | 0 |
| 3 | 1 | 4 | 0 | 5 | 0 | 5 | 5 | 0 |
| Total: | 4 | 11 | 1 | 14 | 0 | 15 | 15 | 0 |

| | | | | |
|---|---|---|---|---|
| Mortality (%): | 73.3 | 93.3 | 100 | 0 |

Experiment #11

In another experiment (“Experiment #11”), adult German cockroaches (Blattella germanica, Blattellinae, Dictyoptera) of mixed sex were collected from a location in downtown Vancouver, British Columbia, Canada on the morning of Nov. 8, 2014 and brought to a UBC research facility. An experimental group of five or six of the cockroaches in each of three RUBBERMAID™ plastic containers (73.6 cm×45.7 cm×33.7 cm) was sprayed with CELATOM™ MN-51 from a 300 gram spray apparatus (as described in U.S. patent application Ser. No. 14/222,335) until runoff. A control group of three of the cockroaches in each of three of the containers was not sprayed with anything.

Mortality was assessed right after spraying, and mortality data are shown in Table 19 below, where “L” refers to a number of cockroaches still living after a corresponding time given in the tables, and where “D” refers to a number that died after the time given. All cockroaches died instantly through direct spraying of CELATOM™ MN-51 aerosol. There was no mortality in the control group.

TABLE 19
Contact toxicity of CELATOM ™ MN-51 aerosol against
Blattella germanica.

| | |
|---|---|
| Experimental Group | Control Group |

| Container Number: | L | D | L | D |
|---|---|---|---|---|
| 1 | 0 | 6 | 3 | 0 |
| 2 | 0 | 5 | 3 | 0 |
| 3 | 0 | 6 | 3 | 0 |
| Total: | 0 | 17 | 9 | 0 |

| | | |
|---|---|---|
| Mortality (%): | 100 | 0 |

Experiment #12

In another experiment (“Experiment #12”), adult common house crickets (Acheta domesticus, Gryllidae, Orthoptera) were purchased from a pet store on the morning of Dec. 8, 2014 and brought to a UBC research facility. An experimental group of five of the crickets of mixed sex in each of three RUBBERMAID™ plastic containers (73.6 cm×45.7 cm×33.7 cm) was sprayed with CELATOM™ MN-51 from a spray apparatus (as described in U.S. patent application Ser. No. 14/222,335) until runoff. A control group of five of the crickets of mixed sex in each of three of the containers was not sprayed with anything. All experiments were conducted at room temperature and humidity.

Mortality was assessed right after spraying, and mortality data are shown in Table 20 below, where “L” refers to a number of crickets still living after a corresponding time given in the tables, and where “D” refers to a number that died after the time given. All crickets died instantly through direct spraying of CELATOM™ MN-51 aerosol. There was no mortality in the control group.

TABLE 20
Contact toxicity of CELATOM ™ MN-51 aerosol against
Acheta domesticus.

| | |
|---|---|
| Experimental Group | Control Group |

| Container Number: | L | D | L | D |
|---|---|---|---|---|
| 1 | 0 | 5 | 5 | 0 |
| 2 | 0 | 5 | 5 | 0 |
| 3 | 0 | 5 | 5 | 0 |
| Total: | 0 | 15 | 15 | 0 |

| | | |
|---|---|---|
| Mortality (%): | 100 | 0 |

### D. Discussion of Experiments and of Uses of Diatomaceous Earth

In general, and without wishing to be bound by any theory, it is believed that diatomaceous earth may damage exoskeletons of animals having exoskeletons, which damage may lead to dehydration and death of the animals. Therefore, it is believed that diatomaceous earth, and various apparatuses such as the string apparatus 100 as described herein for example, may be effective in the control of populations of one or more of animals having exoskeletons, including arthropods, arachnids, insects, silverfish, cockroaches, crickets, and bedbugs. Herein, “silverfish” may refer to Lepisma saccharina, or more generally to Lepismatidae, or still more generally to Thysanura, for example. Also herein, “cockroaches” may refer to Blattella germanica, or more generally to Blattellinae, or still more generally to Dictyoptera, for example. Also herein, “crickets” may refer to Acheta domesticus, or more generally to Gryllidae, or still more generally to Orthoptera, for example. Also herein, “bedbugs” may refer to common bedbugs (Cimex lectularius), or more generally to Cimex, or still more generally to Cimicidae, for example. Animal populations that may be controlled by diatomaceous earth in other embodiments may also include ants, fleas, and other pests. Herein, “control” of an animal population may in various embodiments include prevention of growth or survival of such a population before discovery of the population, and also killing one or more members of such a population after discovery of the population.

Also without wishing to be bound by any theory, it is believed that diatomaceous earth may additionally or alternatively block or otherwise interfere with spiracles on exoskeletons of bedbugs or other pests, thereby diminishing or eliminating passage of air into the trachea of the bedbugs or other pests and potentially asphyxiating the bedbugs or other pests.

Experiment #1 appears to indicate that LC₅₀ for CELATOM™ MN-51 after 48 hours is less than or comparable to LC₅₀ for CELATOM™ MN-53 after 96 hours. In other words, from Experiment #1, CELATOM™ MN-51 appears to kill at least as many bedbugs in 48 hours as CELATOM™ MN-53 kills in 96 hours. Also, Experiment #2 appears to indicate that LC₅₀ and LC₉₅ after 24 hours for CELATOM™ MN-51 are significantly less than LC₅₀ and LC₉₅ after 24 hours for Alpine™ Dust and for PRO-ACTIVE™ because the confidence intervals for those LC₅₀ and LC₉₅ values do not overlap. Moreover, from Experiment #2, CELATOM™ MN-51 appears to kill significantly more bedbugs in 24 hours than Alpine™ Dust kills in 48 hours. Therefore, Experiment #1 and Experiment #2 appear to indicate CELATOM™ MN-51 is more effective at killing bedbugs, and thus in controlling bedbug populations, than CELATOM™ MN-53, Alpine™ Dust, and PRO-ACTIVE™.

Experiment #2 appears to indicate that to LC₅₀ and LC₉₅ after 24 hours for CELATOM™ MN-51 are less than LC₅₀ and LC₉₅ after 24 hours for MotherEarth™ D, but the confidence intervals for those LC₅₀ and LC₉₅ values overlap. Therefore, according to Experiment #2, CELATOM™ MN-51 may be more effective than MotherEarth™ D at killing bedbugs, and thus in controlling bedbug populations, but overlap in the confidence intervals raises some uncertainty. However, Experiment #6 appears to indicate that when one bedbug contacted CELATOM™ MN-51, that one bedbug was generally more effective at killing other bedbugs by transmitting the CELATOM™ MN-51 to the other bedbugs than was the case for MotherEarth™ D. Because bedbugs appear to pick up diatomaceous earth even when briefly exposed to the diatomaceous earth (such as by crossing an area treated with CELATOM™ MN-51 as in Experiment #4 and in Experiment #5), because bedbugs appear to pass diatomaceous earth to other bedbugs (see Experiment #6 and Experiment #7), and because CELATOM™ MN-51 appears to be more effective than MotherEarth™ D in killing bedbugs by transmission of diatomaceous earth from one bedbug to other bedbugs (see Experiment #6), it is believed that overall CELATOM™ MN-51 may be more effective than MotherEarth™ D in controlling bedbug populations.

In view of the foregoing, it is believed that CELATOM™ MN-51 may be more effective in controlling bedbug populations than the other diatomaceous earth products described above.

As indicated above, different insect species have different bodies that may be affected significantly differently by different types of diatomaceous earth. Without wishing to be bound by any theory, it is believed that some characteristics of CELATOM™ MN-51 may increase the effectiveness of CELATOM™ MN-51 when compared to other varieties of diatomaceous earth. For example, some characteristics of CELATOM™ MN-51 may increase the likelihood of diatomaceous earth being transmitted from one bedbug to another, thereby apparently increasing effectiveness of CELATOM™ MN-51 in controlling bedbug populations when compared to MotherEarth™ D as shown in Experiment #6.

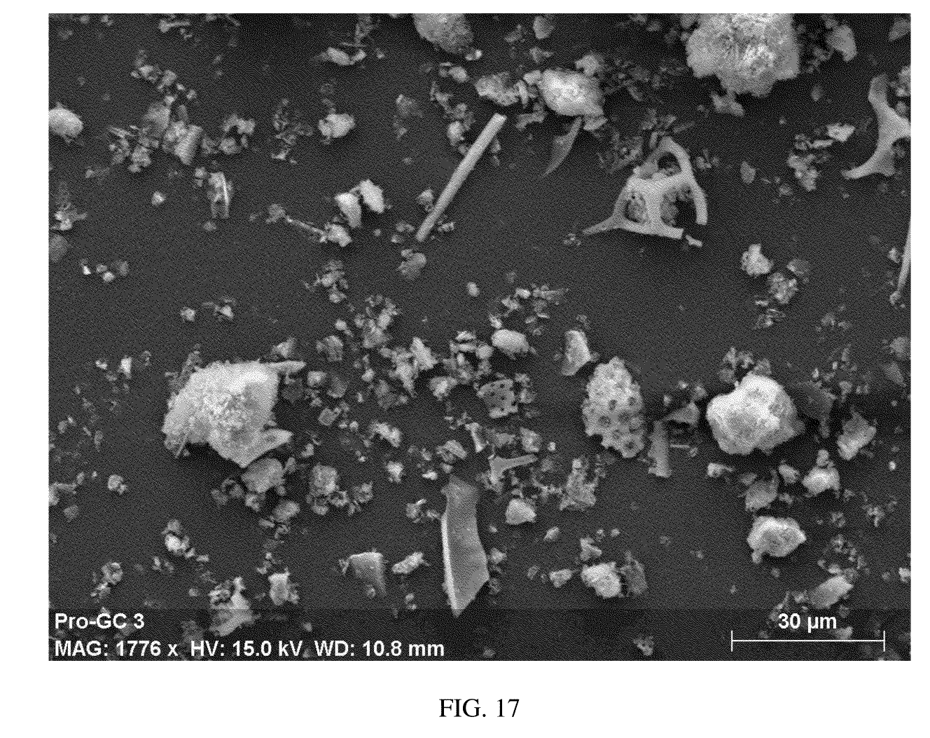

In Experiment #9, a sample of CELATOM™ MN-51 was size separated into a smaller size fraction and into a larger size fraction, and Experiment #9 appears to indicate that the smaller size fraction was significantly more effective than the larger size fraction at killing bedbugs. FIG. 17 illustrates fine grained, broken diatom frustules in the smaller size fraction. Larger grains are absent, but there are aggregates of broken diatom frustules of, roughly, tens of micrometers. In contrast, FIG. 20 illustrates grains that range in size from tens of micrometers to approximately 100 micrometers in length in the larger size fraction. Many grains in FIG. 20 appear not to be diatomaceous material, but rather mineral grains. Therefore, Experiment #9 appears to indicate that the diatom frustules of CELATOM™ MN-51 are more effective at killing bedbugs than other components of CELATOM™ MN-51.

As shown in FIGS. 2 to 5, some of the particles of CELATOM™ MN-51 appear to be remains of diatoms having frustules having widths less than about 3 micrometers or less than about 5 micrometers and lengths greater than about 20 micrometers or greater than about 30 micrometers. It is believed that such diatoms may be Fragilaria, Tabularia, or Synedra, or extinct species having similar size and shape to Fragilaria, Tabularia, or Synedra. More generally, it is believed that such diatoms may be Fragilariaceae, or more generally Fragilariales, or more generally Fragilariophyceae, or more generally pennate diatoms, or extinct species having similar size and shape to Fragilariaceae, Fragilariales, Fragilariophyceae, or pennate diatoms. Herein, reference to “Fragilaria”, “Tabularia”, “Synedra”, “Fragilariaceae”, “Fragilariales”, “Fragilariophyceae”, or “pennate” diatoms in some embodiments may include, in addition to extant species known by such names, extinct species having similar size and shape to Fragilaria, Tabularia, Synedra, Fragilariaceae, Fragilariales, Fragilariophyceae, or pennate diatoms respectively.

Because the diatom frustules of CELATOM™ MN-51 appear to be more effective at killing bedbugs than other components of CELATOM™ MN-51 (see Experiment #9), because CELATOM™ MN-51 appears to be more effective in controlling bedbug populations than the other diatomaceous earth products described above (see Experiment #1, Experiment #2, and Experiment #6), and because CELATOM™ MN-51 appears to include one or more of remains of diatoms having frustules having widths less than about 3 micrometers or less than about 5 micrometers and lengths greater than about 20 micrometers or greater than about 30 micrometers, remains of Fragilaria, remains of Tabularia, remains of Synedra, remains of Fragilariaceae, remains of Fragilariales, remains of Fragilariophyceae, and remains of pennate diatoms, it is believed, without wishing to be bound by any theory, that one or more of remains of diatoms having frustules having widths less than about 3 micrometers or less than about 5 micrometers and lengths greater than about 20 micrometers or greater than about 30 micrometers, remains of Fragilaria, remains of Tabularia, remains of Synedra, remains of Fragilariaceae, remains of Fragilariales, remains of Fragilariophyceae, and remains of pennate diatoms may be more effective than other diatom remains at controlling bedbug populations. Again without wishing to be bound by any theory, it is believed that such diatom remains may be sharper than other diatom remains and thus more likely to pierce or otherwise damage exoskeletons such as bedbug exoskeletons.

Also without wishing to be bound by any theory, it is believed that the size and shape of some particles in CELATOM™ MN-51, such as one or more of remains of diatoms having frustules having widths less than about 3 micrometers or less than about 5 micrometers and lengths greater than about 20 micrometers or greater than about 30 micrometers, remains of Fragilaria, remains of Tabularia, remains of Synedra, remains of Fragilariaceae, remains of Fragilariales, remains of Fragilariophyceae, and remains of pennate diatoms, for example, may block or otherwise interfere with spiracles on exoskeletons of bedbugs, thereby diminishing or eliminating passage of air into the trachea of the bedbugs and potentially asphyxiating the bedbugs, more effectively than other types of diatomaceous earth.

Again without wishing to be bound by any theory, it is believed that in some embodiments, heat treatment or flash drying of CELATOM™ MN-51 may change the characteristics of the diatomaceous earth to be more abrasive and thus more damaging to animal exoskeletons, or more particularly to insect exoskeletons or to bedbug exoskeletons, and that such heat treatment or flash drying may also dry out the diatomaceous earth, thereby making the diatomaceous earth more absorbent to dehydrate and kill an animal or insect such as bedbug and potentially more effective in various embodiments including the various embodiments described herein.

Although CELATOM™ MN-51 has been discussed above, some embodiments may include alternative types of diatomaceous earth that may be supplied by other suppliers but that may include some characteristics of CELATOM™ MN-51 and that thus may have effectiveness similar to the effectiveness of CELATOM™ MN-51. In general, such alternative types of diatomaceous earth in some embodiments may also include one or more of: remains of diatoms having frustules having widths less than about 3 micrometers or less than about 5 micrometers and lengths greater than about 20 micrometers or greater than about 30 micrometers; remains of Fragilaria; remains of Tabularia; remains of Synedra; remains of Fragilariaceae; remains of Fragilariales; remains of Fragilariophyceae; and remains of pennate diatoms. Additionally or alternatively, such alternative types of diatomaceous earth in some embodiments may be heat-treated or flash dried diatomaceous earth, such as diatomaceous earth flash dried at about 480° C. for about 15 seconds for example, or may more generally be modified diatomaceous earth. Such alternative types of diatomaceous earth may also include other types of diatomaceous earth found in deposits formed from fresh-water diatoms, such as the deposit at Clark Station, Nev., United States of America for example. More generally, such alternative types of diatomaceous earth may have one or more properties similar to one or more of the properties of CELATOM™ MN-51 listed in Tables 1 and 2 above in order to achieve effects that may be similar to the effects of CELATOM™ MN-51 described above.

Because Experiment #9 appears to indicate that the smaller size fraction was significantly more effective than the larger size fraction at killing bedbugs, alternative embodiments may include a smaller size fraction of a size-separated diatomaceous earth instead of the diatomaceous earth itself. Again without wishing to be bound by any theory, it is believed that such smaller size fractions may include greater concentrations of relatively more effective diatom frustule remains. Additionally or alternatively, and again without wishing to be bound by any theory, it is believed that such smaller size fractions may more relatively effectively block or otherwise interfere with spiracles on exoskeletons of bedbugs, thereby diminishing or eliminating passage of air into the trachea of the bedbugs and potentially asphyxiating the bedbugs.

Therefore, in various embodiments, the size-separated diatomaceous earth may include CELATOM™ MN-51 for example, and may include diatomaceous earth size-separated by centrifuge. Further, in some embodiments, the smaller size fraction may include or consist of particles less than a separation size, such as about 11 micrometers for example. In embodiments where the diatomaceous earth is size separated by centrifuge, non-spherical particles may be size-separated such that the smaller size fraction may include elongate particles that are longer than the separation size. In general, size separating diatomaceous earth may prepare diatomaceous earth for use in controlling a population of insects, such as for use in the string apparatus 100 shown in FIG. 1 for example.

Experiment #3, Experiment #4, and Experiment #5 appear to indicate that diatomaceous earth is effective at killing bedbugs, and thus in controlling bedbug populations, even if the bedbugs only contact the diatomaceous earth briefly when crossing an area sprayed with diatomaceous earth (see Experiment #4 and Experiment #5). In various embodiments, methods of using such an apparatus may include exposing bedbugs or other pests to diatomaceous earth, for example by spraying, propelling, or otherwise applying the diatomaceous earth to a surface. In some embodiments, when one bedbug contacts the diatomaceous earth, that bedbug may spread the diatomaceous earth to other bedbugs (see Experiment #6 and Experiment #7), and therefore causing one bedbug to contact diatomaceous earth may cause death of several bedbugs. Therefore, in some embodiments, spraying, propelling, or otherwise applying the diatomaceous earth to a surface where bedbugs are likely to be found may be effective even against bedbugs that do not contact the surface where the diatomaceous earth was applied.

Although the foregoing discussion refers primarily to bedbugs, bedbugs have similar anatomies to other pests such as arthropods, arachnids, insects, silverfish, cockroaches, crickets, ants, fleas, and other pests. Experiment #10, Experiment #11, and Experiment #12 indicate that diatomaceous earth that appeared to be effective in control of bedbug populations also appears to be effective in control of silverfish, cockroach, and cricket populations. Therefore, without wishing to be bound by any theory, it is believed that the effectiveness of diatomaceous earth as discussed above with respect to control of bedbug populations may also indicate effectiveness of the same diatomaceous earth with respect to control of silverfish, cockroach, and cricket populations, and more generally to control of populations of other pests with similar anatomies, such as arthropods, arachnids, insects, ants, fleas, and other pests.

The string apparatus 100 and alternative embodiments may be more convenient or effective in the control of such pest populations when compared to other methods of using diatomaceous earth as a pesticide. For example, when plants such as tomatoes or other plants are tied with string such as the string apparatus 100, the diatomaceous earth in the string may facilitate control of pest populations by causing pests (such as insects or arachnids) that walk on the string to die, and also to kill other pests by transmitting the diatomaceous earth to the other pests as indicated in Experiment #6 as discussed above for example. Therefore, tying plants with string such as the string apparatus 100 (instead of some other string) may facilitate control of pest populations without requiring any additional steps to apply pesticide because the pesticide is combined with a cord in such embodiments.

In view of the foregoing, it is believed that some embodiments of the string apparatus 100 and alternative embodiments may effectively control populations of insects such as bedbugs. Therefore, commercial use of embodiments of the string apparatus 100 and of alternative embodiments may involve distributing, selling, offering for sale, placing, or otherwise using such string apparatuses in an effort to control populations of animals, such as animals having exoskeletons, arthropods, arachnids, insects, silverfish, cockroaches, crickets, ants, fleas, and bedbugs for example.

As indicated in Tables 1 and 3 above, some naturally occurring diatomaceous earth is beige in colour. In some embodiments, for example when diatomaceous earth is applied to beige cords, beige diatomaceous earth may be desirable because the colour of the diatomaceous earth may be similar to a colour of the surface to which the diatomaceous earth is applied, so that the diatomaceous earth may desirably be inconspicuous.

However, in some other embodiments in which inconspicuous diatomaceous earth may be desirable, and in which diatomaceous earth is applied to surfaces that are not beige, the beige colour may impart an undesirable appearance to the surfaces to which the diatomaceous earth may be applied. For example, when applying diatomaceous earth, such as the diatomaceous earth described herein for example, to cords that are not beige, the beige colour may impart an undesirable appearance to the plants. Therefore, in some embodiments, diatomaceous earth, such as the diatomaceous earth described herein for example, may be intermixed with a colouring agent to impart a colour to the diatomaceous earth that is similar to the colour of the cord or to any other colour that may be desirable so that the coloured diatomaceous earth is not as noticeable, or not noticeable at all, on the cord.

Examples of colours for colouring agents may include numerous different colours such as red, orange, yellow, green, blue, purple, brown, or other colours. A colouring agent such as bleach for example may also impart a white colour to the diatomaceous earth. In general, various different colours may be appropriate depending on the colour of surfaces where the diatomaceous earth may be applied so that the coloured diatomaceous earth is not as noticeable, or not noticeable at all. In various embodiments, colouring agents that may be intermixed with diatomaceous earth may include colouring agents from Strait-Line™ Hi-Visibility Marking Chalk available from IRWIN Tools. In other embodiments, such colouring agents may include one or more natural dyes from fruits or other sources.

Diatomaceous earth is a natural product, and in some embodiments, natural products may be preferable over other pest control products, such as synthetic pesticides for example, because natural products may be less harmful to humans, to other life, or more generally to the environment. In view of the foregoing, the string apparatus 100 shown in FIG. 1 and alternative embodiments may be advantageous when compared to other methods of controlling bedbug and other insect or pest populations.

Although specific embodiments have been described and illustrated, such embodiments should be considered illustrative only and not as limiting the invention as construed in accordance with the accompanying claims.

What is claimed is:

1. A string apparatus comprising a cord combined with diatomaceous earth.

2. The apparatus of claim 1 wherein the cord comprises twine.

3. The apparatus of claim 1 wherein the cord comprises a generally cylindrical core of fibers.

4. The apparatus of claim 3 wherein at least some of the fibers have end portions that are loose and extend freely away from the core.

5. The apparatus of claim 4 wherein at least some of the diatomaceous earth is on at least some of the end portions.

6. The apparatus of claim 3 wherein at least some of the diatomaceous earth is on an exterior surface of the core.

7. The apparatus of claim 1 wherein the diatomaceous earth comprises remains of pennate diatoms.

8. The apparatus of claim 7 wherein the pennate diatoms comprise Fragilariophyceae diatoms.

9. The apparatus of claim 8 wherein the Fragilariophyceae diatoms comprise Fragilariales diatoms.

10. The apparatus of claim 9 wherein the Fragilariales diatoms comprise Fragilariaceae diatoms.

11. The apparatus of claim 1 wherein the diatomaceous earth comprises remains of diatoms having frustules having widths less than about 5 micrometers and lengths greater than about 20 micrometers.

12. The apparatus of claim 1 wherein the diatomaceous earth comprises remains of diatoms having frustules having widths less than about 3 micrometers and lengths greater than about 20 micrometers.

13. The apparatus of claim 1 wherein the diatomaceous earth comprises remains of diatoms having frustules having widths less than about 5 micrometers and lengths greater than about 30 micrometers.

14. The apparatus of claim 1 wherein the diatomaceous earth comprises remains of diatoms having frustules having widths less than about 3 micrometers and lengths greater than about 30 micrometers.

15. The apparatus of claim 1 wherein the diatomaceous earth is flash dried.

16. The apparatus of claim 1 wherein the diatomaceous earth comprises diatomaceous earth from Clark Station, Nev., United States of America.

17. A method of controlling a population of pests, the method comprising positioning the apparatus of claim 1 in a location where the pests travel.

18. The method of claim 17 wherein positioning the apparatus comprises tying at least one plant with the apparatus.

19. The method of claim 17 wherein the pests comprise insects.

20. The method of claim 19 wherein the insects comprise bedbugs.
